(19) United States
(12) Patent Application Publication
(10) Pub. No.: US 2007/0035101 A1
(43) Pub. Date: Feb. 15, 2007

(54) Disassemblable skateboard for improved portability and carrying system therefor

(76) Inventors: Brett J. Gregory, Santa Clarita, CA (US); Michael W. Keever, Chino, CA (US); Ted J Hauser, Simi Valley, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/542,122

(22) Filed: Oct. 2, 2006

Related U.S. Application Data
(63) Continuation-in-part of application No. 11/197,578, filed on Aug. 3, 2005.
(63) Continuation-in-part of application No. 11/473,948, filed on Jun. 23, 2006.

(51) Int. Cl. B62M 1/00

(52) U.S. Cl. 280/87.042

(57) ABSTRACT

A skateboard that may be easily assembled and disassembled preferably comprises a multiple section deck having one or more mounting mechanisms configured for releasably mounting a truck mounting assembly thereto for joining two deck sections. The truck mounting assembly has a truck assembly and a truck mount attached or integral therewith. In a preferred embodiment, the truck mounting assembly and mounting mechanism are configured for twist-and-lock engagement. Preferably, the truck mount has a mounting cavity for receiving a truck mount connector therein and an internal elongated spring member that biases an engagement member into a slot to prevent unintended disengagement of the truck mounting assembly from the deck. One or more securing mechanisms secure the truck mount to the truck mount connector and the deck. A tab plate and socket plate are provided for use with wooden decks. A carrying system includes a carrying case for transporting the disassembled skateboard.

### CROSS-REFERENCE TO RELATED APPLICATIONS

This patent application is a continuation-in-part of U.S. patent application Ser. No. 11/197,578 filed Aug. 3, 2005 and U.S. patent application Ser. No. 11/473,948 filed Jun. 23, 2006.

### BACKGROUND OF THE INVENTION

A. Field of the Invention

The field of the present invention relates generally to human powered sports and recreational vehicle devices, particularly skateboards and the like. More particularly, the present invention relates to skateboards that are configured to be easily carried and stored when not in use. Even more particularly, the present invention relates to such skateboards having components that are configured for easy assembly into a skateboard and disassembly into its separate components so that the skateboard may be carried in a backpack or like carrying case when not in use.

B. Background

Skateboards are one of the most popular forms of human powered sports and recreational devices that are utilized by a rider to move himself or herself across the ground or other surface. The standard skateboard has an elongated platform having a top surface on which the rider stands and a bottom surface that connects to one or more wheel assemblies that roll across the ground. The platform is sized to allow the rider to be able to place all or a portion of both of his or her feet on the upper surface when riding the skateboard. As well known by persons familiar with skateboards, the rider uses one of his or her feet to propel the skateboard and uses the tilting action of his or her body, usually with both feet generally transversely disposed on the platform, to change the skateboard's direction of travel. Although in the past the platform was almost always configured to be substantially planar and made out of wood, modern skateboards are known to have a variety of shapes, including generally uplifting ends, and be made out of a variety of different types of materials, including various metal, thermoplastic and composite materials. The typical wheel assembly comprises a pair of truck mechanisms having a plurality of wheels, typically two for each truck, that are rotatably connected to the truck axle. For the standard skateboard, the truck mechanisms are fixedly attached to the underside of the board with mechanical connectors, such as rivets, screws or bolts, or specially configured adhesives. Some modern skateboards are configured with truck assemblies that provide for a pivoting type of motion relative to the plane of the surface on which the skateboard is being ridden to allow the rider more control of the skateboard's movement.

Although skateboard riding is popular among people of all ages, it tends to be most popular among younger riders who like to ride the skateboard as a means of transportation to get to school, stores, after school sports practices, movies and other activities in addition to use for general recreation. A significant problem for use of a skateboard as a means of transportation, for riders of all ages, is what to do with the skateboard once the rider gets to where he or she is going. Although most people can carry the standard skateboard, it is not necessarily small or lightweight and most people do not want to carry a skateboard around with them while they walk to and from classes or around the store or other activity. Storage of the skateboard in a locker or other container is generally not practical. Most skateboards are not configured for attachment to bicycle racks or other storage areas. To compound the problem, many of the destinations typically where a rider is likely to go, such as schools and stores, do not allow skateboard riding on the premises. This is a particular problem with regard to schools, which is perhaps the most convenient and logical destination for younger skateboard riders, which often have very strict rules regarding the riding or even carrying of skateboards on the campus due to safety and discipline concerns. Many stores, malls and like areas also do not want their patrons to be walking around carrying a skateboard. Because there is typically no real satisfactory outside storage solution that provides convenient and safe (i.e., to avoid theft or persons tripping over the skateboard) storage of the rider's skateboard, the utility of a skateboard as a means of transportation to get to school, stores and other destinations is generally substantially limited.

Due to the aforementioned carrying and storage problems, there is a need to provide a skateboard that is easier to carry and store. A number of patents are directed to skateboards that are configured to be detachable or foldable so as to be more easily carried and stored by the rider when not in use. For instance, U.S. Pat. No. 6,631,913 to Godfrey describes a detachable interchangeable skateboard having an H-shaped locking brace that interconnects two halves of the skateboard, each having a top and bottom platform, configured to allow the user to change the top platform to change the look of the skateboard and/or replace worn components. The wheel assemblies are attached to the lower platform. U.S. Pat. No. 6,131,931 to Globerson, et al. describes a folding skateboard having a three-piece platform with the sections hinged together and configured such that when the skateboard is folded the trucks and wheels of the skateboard, which are attached to the front and back platform sections, are adjacent to each other. Rods, clips or other members hold the skateboard in its folded configuration. U.S. Pat. No. 5,769,438 to Svetlov describes a three-piece folding skateboard that has a locking mechanism that extends or retracts a pair of rods from a pair of receiving elements to secure the skateboard in an extended position or to allow the user to fold the skateboard. U.S. Pat. No. 5,505,474 to Yeh describes a folding skateboard that has a frame made up of frame bars connected by links and a pair of pivoting couplings that connect the wheel assemblies to the frame. A foot plate is supported by each of the wheel assemblies. U.S. Pat. No. D505,470 to Hong illustrates a folding skateboard having a three-piece platform with hinges on top to foldably connect the platform sections. U.S. Pat. No. D473,905 and U.S. Publication No. 2003/0127816, both to Schnuckle, et al., describe foldable skateboards of substantially different configuration than the standard skateboard that has an articulating structure that can be folded for carrying or storage. The skateboard described in the Schnuckle patents appears to be available as the Stowboard™, available from Stowboards.com. U.S. Pat. No. 5,540,455 to Chambers describes an articulating skateboard that articulates and pivots. U.S. Pat. No. 4,458,907 to Meredith describes a skateboard that allows the user to extend or retract the length of the platform.

While the foregoing patents generally describe detachable or foldable skateboards that may reduce the overall length of the skateboard, the folded condition of the skateboards appear to be somewhat bulky and, as a result, not necessarily much easier to carry than a conventional skateboard. The bulky nature of these skateboards is because, at least in part, the truck or wheel assemblies are not configured for easy removal. In fact, no known skateboard provides an assembly for easily and quickly removing the truck wheel assemblies from the platform. In addition, some of the foregoing appear to have folding or bending apparatuses that provide a skateboard which is not fully secured when it is placed in the extended, riding position. This would appear to present problems from a riding enjoyment and safety standpoint.

What is needed, therefore, is a skateboard that is more fully disassemblable so as to better facilitate carrying and storage of the skateboard when it is not in use and which can be securely placed in the rideable position when assembled. The preferred disassemblable skateboard should have components that are easily and quickly assembled and disassembled without the use of any tools. The preferred skateboard should be adaptable for being manufactured out of relatively lightweight, strong materials to reduce the burden on the user when he or she is carrying the skateboard when not in use. The preferred skateboard should also be adaptable for fitting into a backpack or like carrying case without unduly utilizing much of the available carrying space. The preferred portable skateboard should be adaptable for use with a variety of different types and styles of skateboard platforms and truck assemblies.

### SUMMARY OF THE INVENTION

The disassemblable skateboard for improved portability of the present invention solves the problems and provides the benefits identified above. That is to say, the present invention discloses an improved portable skateboard that is easily and quickly disassembled into relatively easy to carry and store components that can be easily and quickly reassembled into the skateboard for riding. The present invention also discloses a carrying system that is particularly configured to carry the components of the disassemblable skateboard when in their disassembled state. The portable skateboard of the present invention can be assembled and disassembled without the use of tools and, when assembled, provides a secure, stable platform for safely riding the skateboard. In the preferred embodiment, the disassembled components of the portable skateboard can be conveniently stored in a cooperatively configured backpack or other carrying case or storage container, including lockers and the like, when not in use. Preferably, the portable skateboard of the present invention is made out of strong, lightweight materials and configured so as to reduce the weight of the skateboard to be easily carried when it is not in use. In a preferred embodiment, the portable skateboard of the present invention has a pair of truck assemblies that separate from a three-piece, separatable platform, with the truck assemblies configured to securely join adjacent sections of the platform together into a unified skateboard. The portable skateboard of the present invention can be used with a variety of different types and styles of skateboard platforms and truck assemblies.

In one general aspect of the present invention, the disassemblable skateboard for improved portability includes a deck comprised of a first end section, a second end section and a center section disposed therebetween. The deck sections are configured to join to together to form an integral deck suitable for riding. A first mounting mechanism is at the junction of the first end section and the second end section and a second mounting mechanism is at the junction of the second end section and center section. A first truck mounting assembly, having a truck mount, truck base, axle and one or more wheels rotatably attached to the axle, mounts to the first mounting mechanism in a manner that abuttingly joins the first end section to the center section. A second truck mounting assembly, also having a truck mount, truck base, axle and one or more wheels rotatably attached to the axle, mounts to the second mounting mechanism in a manner that abuttingly joins the second end section to the center section. In the preferred embodiment, each of the first and second mounting mechanisms comprises an outwardly projecting truck mount connector on the bottom surface of the deck that is engagedly received in a mounting cavity on the truck mount such that the truck mounting assemblies are securely mounted to the deck using a twist-and-lock type of engagement.

Preferably, the twist-and-lock engagement is achieved by cooperative engagement of projecting and receiving lips on the truck mount connector and truck mount, respectively, and with the use of a spring member disposed in the cavity that is attached to the truck mount so as to bias an engagement member, which is attached to or integral with the spring member, into a slot disposed in the truck mount connector. When the truck mounting assemblies are twisted onto the connectors, the engagement member is first biased upward into the mounting cavity and then, when aligned with the slot, it is biased downward into the slot. Placement of the engagement member into the slot prevents any further rotation of the mounting assembly so as to secure it on the bottom surface of the deck. A guide member is attached to or integral with the end of the spring member to allow the user to move the engagement member out of the slot in order to disengage the mounting assembly from the deck of the skateboard. A truck mount securing mechanism secures the engagement member of the truck mount in the slot of the truck mount connector. In the preferred embodiment, the truck mount securing mechanism comprises a spring-biased button in a button aperture located on the guide member. Preferably, the button is automatically biased outward when the engagement member is received in the slot such that the user must push the button to overcome the spring force to allow him or her to slide the guide mechanism upward to disengage the wheel mount from the wheel mount connector. In an alternative embodiment, a spring-driven ball in the truck mount cooperates with a detent in the guide member to hold the guide member in position, thereby preventing the engagement member from moving out of the slot. In another embodiment, a slide mechanism mounted on the deck has a retainer bar that slides into a channel in the engagement member to prevent the engagement member from coming out of the slot. A bar lock member can cooperatively engage a detent on the retainer bar to prevent it from sliding out of the channel.

In another embodiment, a first securing mechanism secures the first truck mounting assembly to the bottom surface of the deck and a second securing mechanism secures the second truck mounting assembly to the bottom surface of the deck. In one configuration, each of the truck mounting assemblies comprises a generally resilient outwardly extending member that is configured to engage a securing assembly so as to secure the truck mounting assemblies to the bottom surface of the deck. The outwardly extending members have a locking projection that engages a locking cavity on the securing assembly. The resilient nature of the outwardly extending member assisting in pushing the locking projection into the locking cavity. In another embodiment, the securing assembly comprises a ramp section that guides the locking projection into engagement with the locking cavity. The securing assembly can also comprise an extension member, which is slidably engaged in a base member attached to the bottom surface of the deck, that is configured to engage a locking aperture on the truck mount of each of the truck mounting assemblies. In yet another embodiment, the securing assembly comprises a pair of deck receptacles in the bottom surface of the deck and the truck mount of the truck mounting assemblies include a pair of outwardly extending bracket extensions that are configured to be received in the deck receptacles so as to join adjacent sections of the deck together. The securing assembly can also include an extension member attached to a securing latch that is biased by one or more springs to drive the extension member into a locking aperture located on the side of the truck mount component of the truck mounting assemblies.

For decks made out of wood or other materials, the skateboard can comprise a tab plate having one more tabs or pins extending outwardly from the end of one of the deck sections that are configured to be received in the like-configured and numbered sockets of a socket plate attached to an adjoining section of the deck to guide the two sections together. In one configuration, with the deck provided in a first end section, a second end section and center section disposed therebetween, the interior end of each of the first and second end sections can have a tab plate with a pair of tabs or pins extending outwardly from the end plate (i.e., toward the center section) and each end of the center section can have a socket plate with a pair of like-configured sockets that receive the tabs or pins when the end sections are in abutting relation to the center section. Each of the tab plate and the socket plate can have one half of the outwardly extending truck mount connector such that the joining of the tabs/pins into the sockets join the truck mount connector together. The twist-and-lock mounting of the truck mounts secures the end sections to the center section to define a unitary deck suitable for skateboard riding.

In one configuration of the carrying system of the present invention, the system comprises a carrying case that is cooperatively configured with a disassemblable skateboard configured according to the various embodiments described above. The carrying case has specially provided pockets that are sized and configured to receive one or more of the disassembled components of the skateboard. In one configuration, the carrying case is configured similar to a standard backpack that is modified for use with a three piece deck and removable truck assemblies. The backpack has an interior skateboard compartment with an elongated pocket for the center section, two end sections pockets for receiving and end section into each pocket and two truck assembly pockets for receiving a truck assembly into each pocket. In the preferred embodiment, the skateboard compartment is separately enclosed with a zipper or other closure mechanism. Alternatively, the skateboard compartment can be sized to carry other materials in addition to the skateboard components. Various other compartments are provided, as with a standard backpack, for carrying (as an example) books, notebooks, paper and other school materials Accordingly, the primary objective of the present invention is to provide a portable, disassemblable skateboard that provides the advantages discussed above and that overcomes the disadvantages and limitations associated with presently configured skateboards, including foldable, disassemblable or otherwise portable skateboards.

It is also an object of the present invention to provide a portable skateboard that is quickly and easily assembled into a secure, stable skateboard for riding or quickly and easily disassembled into separate components for storage and carrying.

It is also an object of the present invention to provide a portable skateboard that is quickly and easily assembled or disassembled without the use of tools or other devices.

It is a further object of the present invention to provide a portable skateboard comprising a multiple piece platform that is separatable from the truck assemblies so as to facilitate easy carrying and storage of the skateboard when not in use, including storage of the components in a backpack or other suitable carrying case that is cooperatively configured to receive the disassembled components of the skateboard.

It is a further object of the present invention to provide a portable skateboard which is adaptable for use with a variety of different types and styles of skateboards and truck assemblies.

It is a further object of the present invention to provide a portable skateboard having truck mounting mechanisms that allow the user to quickly and easily remove the truck assemblies from the skateboard platform so as to reduce the bulk thereof for easier carrying and storing of the skateboard.

It is a further object of the present invention to provide a portable skateboard having a multiple component platform and a pair of truck mounting mechanisms that are configured to securely join adjacent platform components together to provide a stable and safely rideable skateboard.

It is a further object of the present invention to provide a portable skateboard having a locking mechanism which lockingly engages a truck mount attached to the truck assembly to secure the truck mount to a multiple piece platform so as to securely connect the separate pieces into a single, stable platform for skateboard riding.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a top perspective view of the disassemblable skateboard for improved portability configured according to one embodiment of the present invention shown in its assembled condition;

FIG. 2 is a bottom view of the disassemblable skateboard of FIG. 1 showing the truck mounting assemblies mounted and secured to the platform;

FIG. 3 is a bottom view of the disassemblable skateboard of FIG. 2 showing the platform with the truck assemblies removed from the truck mount connectors;

FIG. 4 is an exploded view of the disassemblable skateboard of FIG. 3 particularly showing the separate sections of the deck;

FIG. 5 is a front perspective view of the first end of the rearward end section of the deck of the disassemblable skateboard of FIG. 4;

FIG. 6 is a rear perspective view of the second end of the center section of the deck of the disassemblable skateboard of FIG. 4;

FIG. 7 is a bottom perspective view of one of the truck mounting assemblies of the disassemblable skateboard of FIG. 2;

FIG. 8 is a top perspective view of the truck mounting assembly of FIG. 7;

FIG. 9 is an isolated bottom plan view of the disassemblable skateboard of FIG. 2 showing the truck mounting assembly attached to the platform and secured into place by the locking and securing assemblies, with the locking assembly shown in the locked condition and the securing assembly shown in the secured condition;

FIG. 10 is an isolated bottom plan view of the disassemblable skateboard of FIG. 9 with the locking assembly shown in the locked condition and the securing assembly shown in the unsecured condition;

FIG. 11 is an isolated bottom plan view of the disassemblable skateboard of FIG. 10 with the truck mount assembly shown unlocked and disengaged from the locking assembly;

FIG. 12 is an isolated bottom plan view of the disassemblable skateboard of FIG. 11 shown with the truck mount assembly in position for removal from the platform;

FIG. 13 is an alternative embodiment of the disassemblable skateboard of the present invention shown with the forward/first truck mounting assembly unlocked and disengaged from the locking mechanism and the rearward/second truck mounting assembly secured in place by the locking mechanism;

FIG. 14 is another alternative embodiment of the disassemblable skateboard of the present invention shown with the forward/first truck mounting assembly unlocked and disengaged from the locking mechanism and the rearward/second truck mounting assembly secured in place by the locking mechanism;

FIG. 15 is an exploded view of the platform utilized with the embodiment of the disassemblable skateboard shown in FIG. 14;

FIG. 16 is a top perspective view of the truck mounting assembly utilized with the embodiment of the disassemblable skateboard shown in FIG. 14;

FIG. 17 is a bottom perspective view of the truck mounting assembly for use with the disassemblable skateboard of FIG. 14 shown mounted on the platform but disengaged from the locking mechanism;

FIG. 18 is a side view of another alternative embodiment of the disassemblable skateboard of the present invention;

FIG. 19 is a top view of the three platform components of the disassemblable skateboard of the embodiment of the present invention shown in FIG. 18;

FIG. 20 is a partially exploded bottom view of the disassemblable skateboard of the embodiment of the present invention of FIG. 18 shown with the forward truck mounting assembly mounted to the platform and the rearward end section of the platform separated from the center section of the platform;

FIG. 21 is a side view of the truck mounting assembly showing the truck assembly and truck mount of the embodiment of the disassemblable skateboard used with the embodiment shown in FIG. 18;

FIG. 22 is a front view of the truck mounting assembly of FIG. 21;

FIG. 23 is a rear view of the truck mounting assembly of FIG. 21;

FIG. 24 is an exploded bottom perspective view of the locking assembly and truck mount of the embodiment of the disassemblable skateboard of FIG. 18;

FIG. 25 is an exploded top perspective view of an end of the deck of the preferred embodiment of the present invention showing a configuration for the attachment of bumper guards to the deck;

FIG. 26 is a bottom perspective view of the disassemblable skateboard of a preferred embodiment of the present invention showing the first end section joined to the center section of the deck with the truck mount, without the truck assembly, attached to the truck mount connector;

FIG. 27 is a bottom perspective view of the skateboard of FIG. 26 with the truck mount removed from the truck connector;

FIG. 28 is a cross-sectional side view of the truck mount of FIG. 26 taken through the center of the truck mount;

FIG. 29 is a bottom perspective view of the truck mount of FIG. 26;

FIG. 30 is a side cross-sectional view of the spring locking mechanism of the truck mount of FIG. 26;

FIG. 31 is a bottom perspective view of the spring locking mechanism of FIG. 30;

FIG. 32 is a bottom perspective view of an alternative embodiment of the present invention showing the use of a slide mechanism to secure the truck mount to the truck mount connector;

FIG. 33 is a bottom view of a truck mount configured for use with the slide mechanism of FIG. 32;

FIG. 34 is a side perspective view of the spring locking mechanism configured for use with the slide mechanism of FIG. 32;

FIG. 35 is a side cross-sectional view of the truck mount configured for use with the slide mechanism of FIG. 32;

FIG. 36 is a cross-sectional side view of the embodiment of FIG. 32 showing the slide mechanism engaging the truck mount to secure the truck mount to the deck;

FIG. 37 is a top perspective view of the truck mounting assembly of the preferred embodiment of the present invention shown with a portion of a truck assembly attached thereto;

FIG. 38 is bottom perspective view of the truck mount of FIG. 37;

FIG. 39 is an exploded top perspective view of the truck mount of FIG. 37;

FIG. 40 is an exploded bottom perspective view of the truck mount of FIG. 37;

FIG. 41 is a top perspective view of the latching mechanism of the preferred embodiment of the truck mounting assembly of the present invention;

FIG. 42 is a partially exploded bottom perspective view of the latching mechanism of FIG. 41;

FIG. 43 is a bottom view of an embodiment of the present invention showing the use of tab plates, with tabs extending therefrom, and socket plates, with sockets formed thereby, that is particularly useful with wooden decks and the like, with the first end section separate from the center section and the second end section in abutting relation with the center section;

FIG. 44 is an end view of the first end of the center section of the embodiment of FIG. 43 particularly showing the socket plate and the sockets therein;

FIG. 45 is an end view of the second end of the first end section of the embodiment of FIG. 43 particularly showing the tab plate and the tabs extending outwardly therefrom;

FIG. 46 is a side perspective view of a carrying case, in the form of a backpack, for use with the carrying system of the present invention; and

FIG. 47 is a top plan view of the backpack of FIG. 46 with the skateboard compartment open to show the pockets for receiving sections of the deck therein.

### DETAILED DESCRIPTION OF THE PREFERRED EMBODIMENTS

With reference to the figures where like elements have been given like numerical designations to facilitate the reader's understanding of the present invention, and particularly with regard to the embodiment of the disassemblable skateboard for improved portability of the present invention illustrated in the figures, various preferred embodiments of the present invention are set forth below. The enclosed description and drawings are merely illustrative of preferred embodiments and represent several different ways of configuring the present invention. Although specific components, materials, configurations and uses of the present invention are illustrated and set forth in this disclosure, it should be understood that a number of variations to the components and the configuration of those components described herein and in the accompanying figures can be made without changing the scope and function of the invention set forth herein.

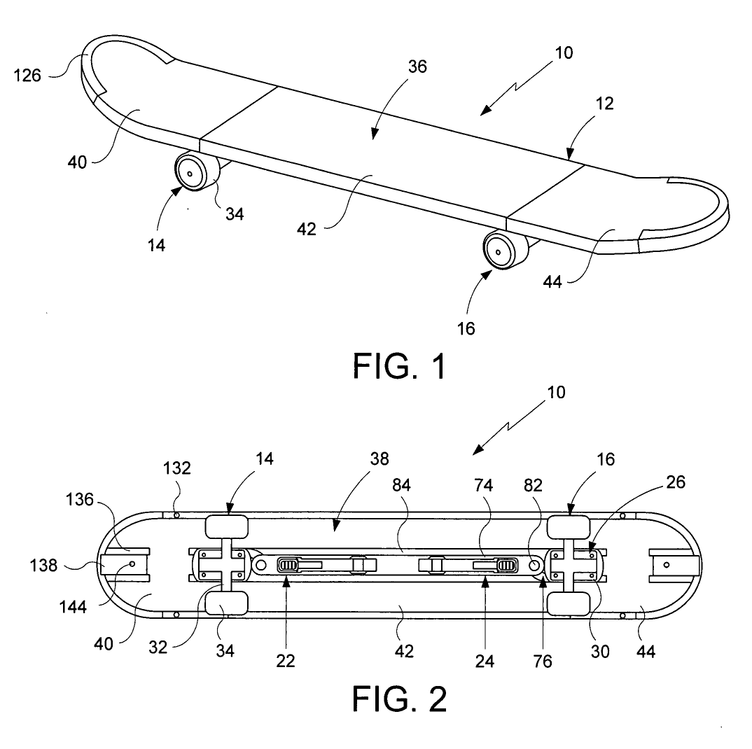

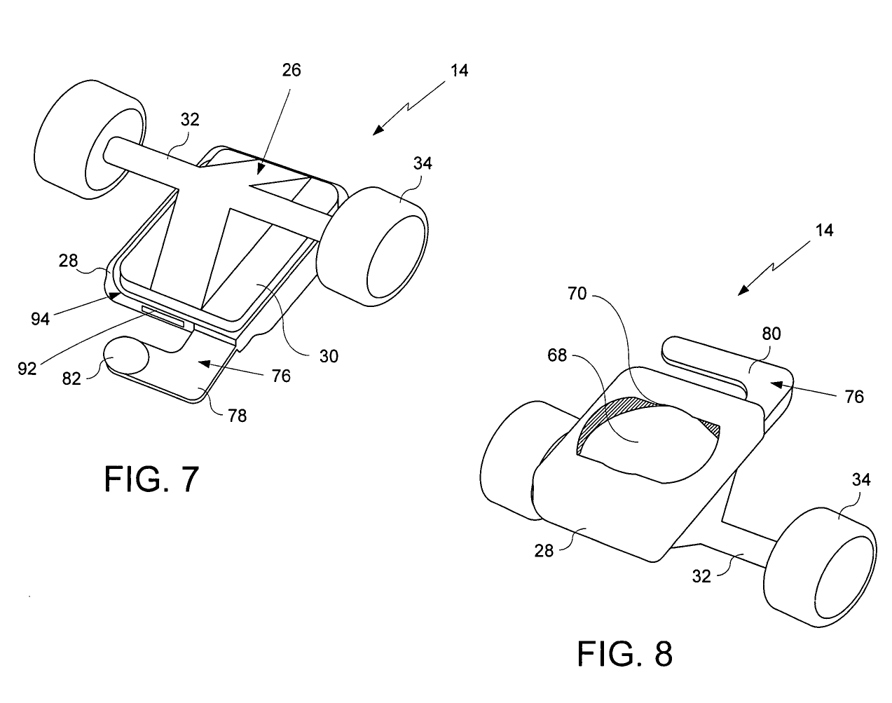

In the preferred embodiments of the disassemblable skateboard for improved portability of the present invention, shown in the figures, the portable skateboard is identified generally as 10. FIGS. 1 and 2 included herewith show one of the embodiments of portable skateboard 10 in its assembled or rideable condition, with the front or forward end of skateboard 10 on the left and the back or rearward end of skateboard 10 on the right. As shown in FIGS. 1 through 4, portable skateboard 10 primarily comprises deck 12, front or first truck mounting assembly 14, rear or second truck mounting assembly 16, front or first mounting mechanism 18, rear or second mounting mechanism 20, front or first securing mechanism 22 and rear or second securing mechanism 24. As shown in FIGS. 7 and 8 with regard to first truck mounting assembly 14, with second truck mounting assembly 16 being configured the same, each of the first 14 and second 16 truck mounting assemblies comprise a truck assembly 26 attached to or integral with truck mount 28. Truck assembly 26 of the preferred embodiments of the present invention is a standard truck assembly that comprises a truck base 30, axle 32 and a pair of wheels 34 rotatably attached to axle 32. As well known in the art, the heretofore available skateboards and truck assemblies are configured such that truck base 30 is attached directly to deck 12, with wheels 34 extending outwardly therefrom for riding on a sidewalk, street or other surface. Although truck assembly 26 for first 14 and second 16 truck mounting assemblies may be specially configured for skateboard 10 of the present invention, it is preferred that truck assembly 26 be one of the standard, typical or “high tech” truck assemblies in use with presently available skateboards so as to reduce the cost and obtain the benefit of such presently existing truck assemblies. As shown in the figures, it is preferred that truck mount 28 be a separate component and truck base 30 be fixedly attached thereto in the same manner as truck base 30 for current truck assemblies 26 attach to deck 12 (i.e., using screws, bolts, rivets, adhesives or other connecting mechanisms). In an alternative embodiment, truck mount 28 can be made integral with truck assembly 26 such that truck mount 28 and truck assembly 26 are a single component which attaches to deck 12 in the manner described below with regard to the preferred embodiment. As set forth below, truck mount 28 is configured to removably attach to first mounting mechanism 18 or second mounting mechanism 20 so the user of skateboard 10 can remove first truck mounting mechanism 14 and second truck mounting mechanism 16 to reduce the size and configuration of skateboard 10 to make it easier to carry.

As well known in the art, deck 10 has a top surface 36 configured for the user to stand on and a bottom surface 38 to which, in the typical prior art skateboard, truck base 30 of truck assembly 26 attaches. In one configuration of the present invention, skateboard 10 has a single piece deck 12 with removable first 14 and second 16 truck mounting assemblies that enable the user to reduce the weight and bulk of skateboard 10 so as to more easily carry the components (i.e., deck 12, first truck mounting assembly 14 and second truck mounting assembly 16) separately for ease in distributing the weight and fitting within a backpack or other carrying case. As known to those familiar with skateboards, typically the conventional truck assemblies are only removable by use of a screwdriver, wrench, hex driver or some other tool. Use of the single piece deck 12 with first 18 and second 20 mounting mechanisms and first 14 and second 16 truck mounting assemblies of the present invention, as described in more detail below, allows the user to quickly and easily assemble skateboard 10 for riding or to quickly and easily disassemble skateboard 10 for storage or carrying. The heretofore available skateboards do not allow the user to essentially reduce skateboard 10 to a generally flat deck 12 and separate first 14 and second 16 truck mounting assemblies in a quick and easy manner. Once separated or disassembled, the deck 12 can be carried in a compartment separate from first 14 and second 16 truck mounting assemblies.

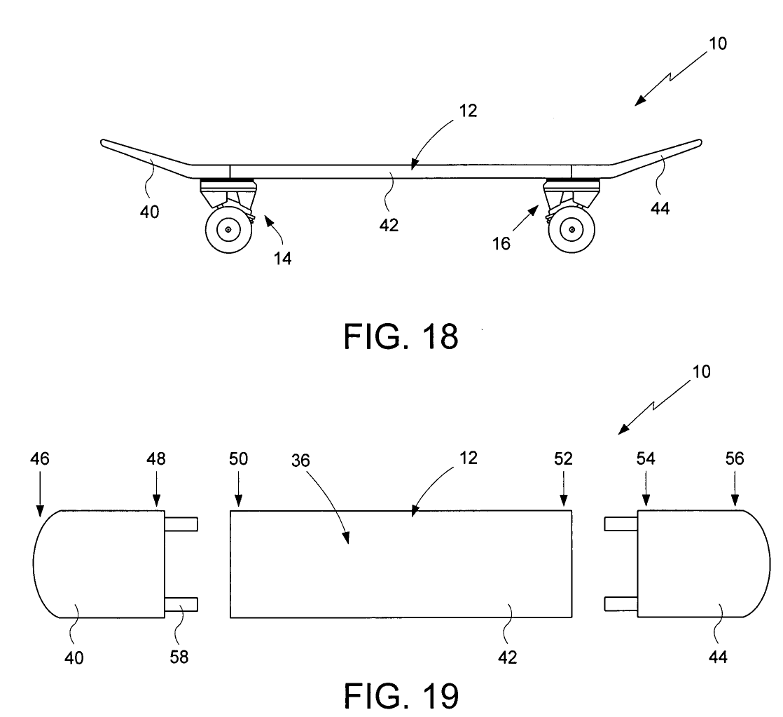

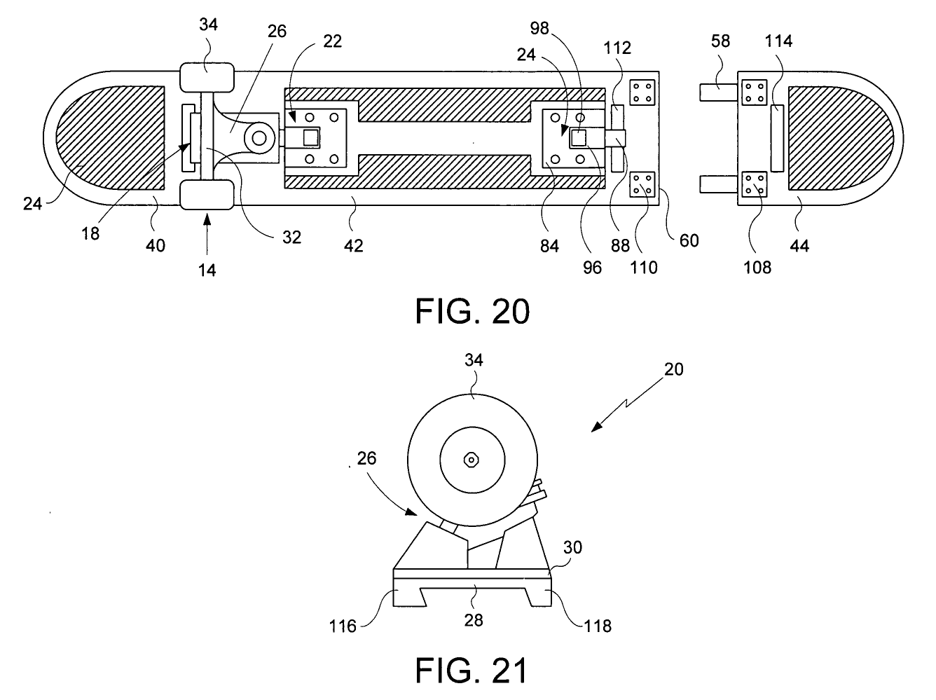

In a preferred embodiment of the present invention, skateboard 10 has a deck 12 which can be separated into two or more separate deck sections. In the preferred embodiment, deck 12 can be separated into three deck sections, namely forward or first end section 40, center section 42 and rearward or second end section 44, as best shown in the exploded views of FIGS. 4 and 15 and the partially exploded view of FIG. 20. For purposes of describing the embodiments herein, first end section 40 has a first end 46 and a second end 48, center section 42 has a first end 50 and a second end 52, and second end section 44 has a first end 54 and second end 56. In this embodiment, first truck mounting assembly 14 is utilized to abuttingly join the second end 48 of first end section 40 to the first end 50 of center section 42 and second truck mounting assembly 16 is utilized to abuttingly join the second end 52 of center section to first end 54 of second end section 44 to provide a substantially unified deck 12, as best shown in FIGS. 1 and 2. Various configurations for first 14 and second 16 truck assemblies, in conjunction with first 18 and second 20 mounting mechanisms, can be utilized to accomplish the secured joined deck sections to provide a stable and safe to use deck 12 and accomplish the easy and quickly assembly and disassembly objectives desired for the improved portable skateboard 10 of the present invention. Preferred configurations for these components are set forth in more detail below and in the accompanying figures. As known to those skilled in the art, assembled deck 12 can be configured so as to be generally planar throughout its length or first 40 and second 44 end sections can be configured to be slightly to somewhat inclined, as best shown in FIG. 18, with only center section 42 being generally planar to achieve certain aesthetic and performance objectives for skateboard 10.

To ensure that skateboard 10 is safe and suitable for riding use, it is important that first 14 and second 16 truck mounting assemblies be cooperatively configured with first 18 and second 20 mounting mechanisms, respectively, such that once the separate sections of deck 12 are joined they are held tightly against each other and are locked and remain locked in such abutting relation until the user desires to disassemble skateboard 10 for carrying or storage. As would be understood by those skilled in the art, gaps between the joined sections (such as first end section 40 and center section 42) could create problems and be unsafe for the rider, particularly if barefoot. Likewise, the enjoyment and safety of skateboard 10 would be substantially reduced if deck 12 of skateboard 10 were to separate or tend to separate unexpectedly during use. To prevent such occurrences, it is preferred that skateboard 10 utilizes a more than one system of locking or securing first 14 and second 16 truck assemblies onto bottom surface 38 of deck 12, particularly when such assemblies are used to securely join deck sections, such as 40, 42 and 44, together into unified deck 12.

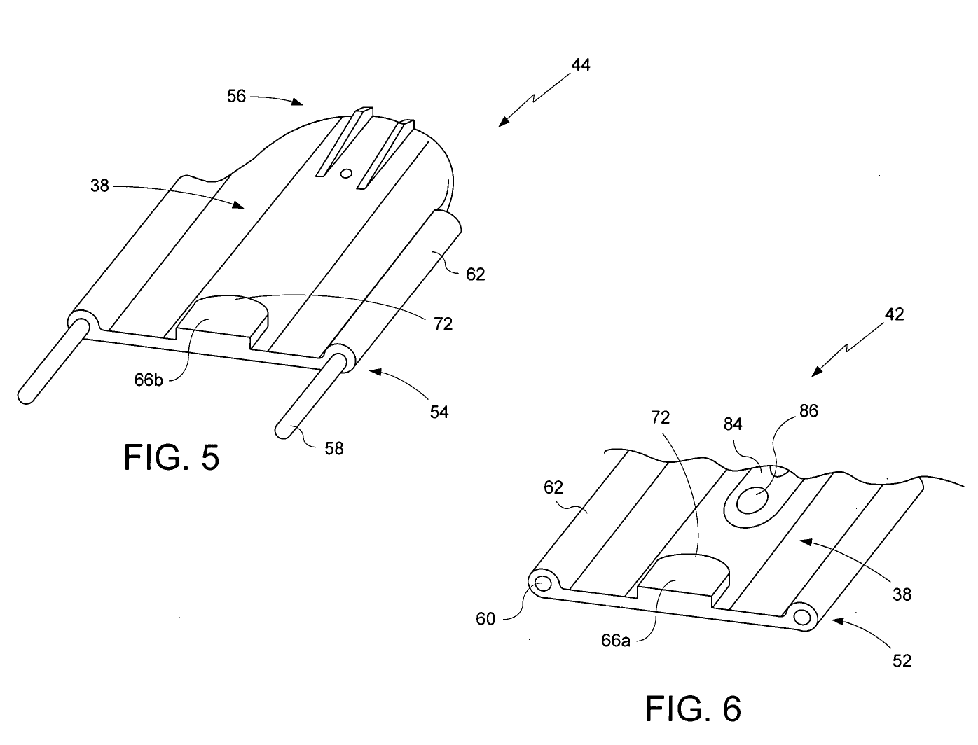

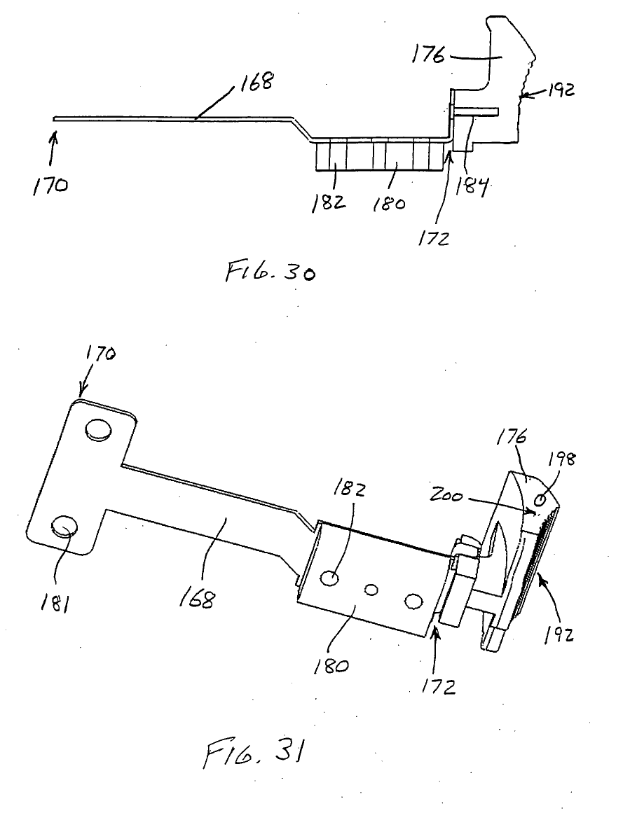

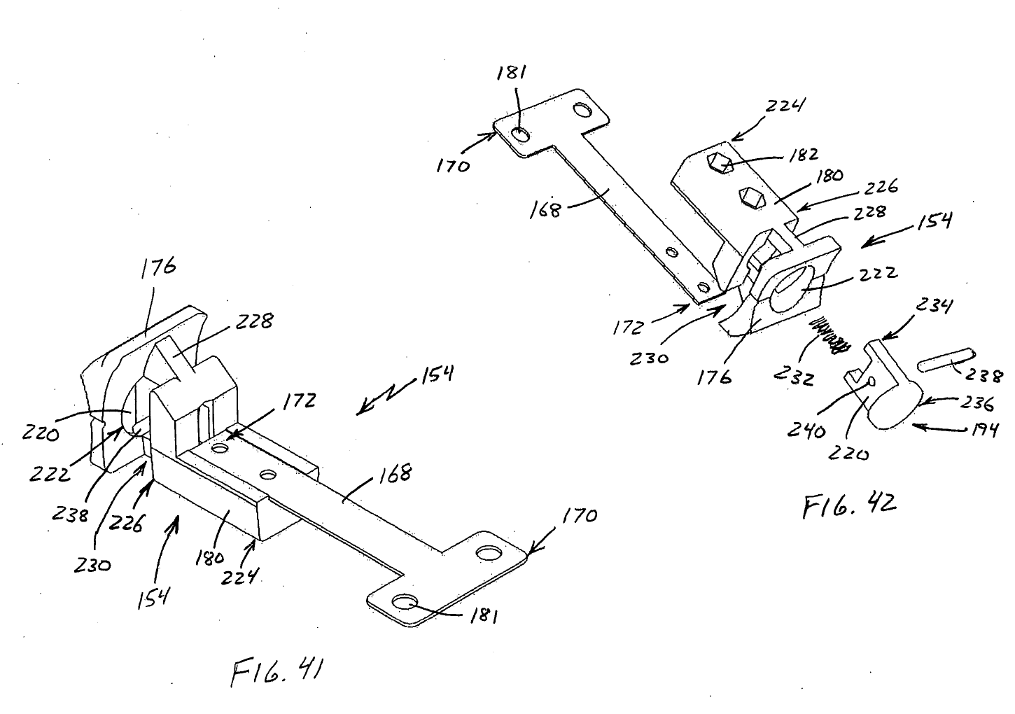

In the preferred embodiments of the present invention, shown in FIGS. 1 through 12 and FIGS. 26 through 42, deck 12 is provided in three separatable sections, first end section 40, center section 42 and second end section 44, that are guided into the desired abutting relationship by use of a pin and socket type of arrangement. As best shown in FIGS. 5 and 6 with regard to second end section 44 and center section 42, respectively, the first end 54 of second end section 44 is provided with an outwardly extending pin 58 and second end 52 of center section 42 is provided with a cooperatively configured socket 60 which receives pin 58 therein when second end section 44 is joined to center section 42. As shown in FIG. 4, second end 48 of first end section 40 also has pins 58 and first end 50 of center section 42 also has sockets 60 to join first end section 40 to center section 42. In a preferred embodiment of deck 12, for ease of manufacturing the outer edges 62 of deck 12 are configured to be generally tubular with the channel therein forming socket 60. Pin 58 can be co-formed (i.e., co-extruded or the like) with edges 62 or pin 58 can be fixedly inserted inside the channel of tubular edge 62 using adhesives or other materials suitable for fixing pin 58 inside the channel (i.e., socket 60) of tubular edge 62. In the embodiment of FIGS. 5 and 6, pin 58 is a generally elongated, cylindrically shaped outwardly extending member and socket 60 is configured to be a cooperatively sized (i.e., such that pin 58 has a diameter that is slightly smaller than that of socket 60) opening such that pin 58 is slidably received in socket 60 to reduce the amount of unwanted flexing between second end section 44 and center section 42. However, the invention is not so limited. As will be readily apparent to those skilled in the art, the pin 58 and socket 60 configuration described above can be modified in a number of different ways to accomplish the objectives herein, namely guiding the separate sections of deck 12 together into abutting relationship. For instance, the location of pin 58 and socket 60 can be reversed, such that first 50 and second 52 ends of center section 42 have pins 58 and second end 48 of first end section 40 and first end 54 of second end section 44 have the sockets. In addition, as shown in FIGS. 19 and 20, pin 58 can be a generally rectangular, flat outwardly extending member that is received by a cooperatively configured, generally rectangularly shaped opening that receives the pin 58 therein. Various other combinations are also possible.

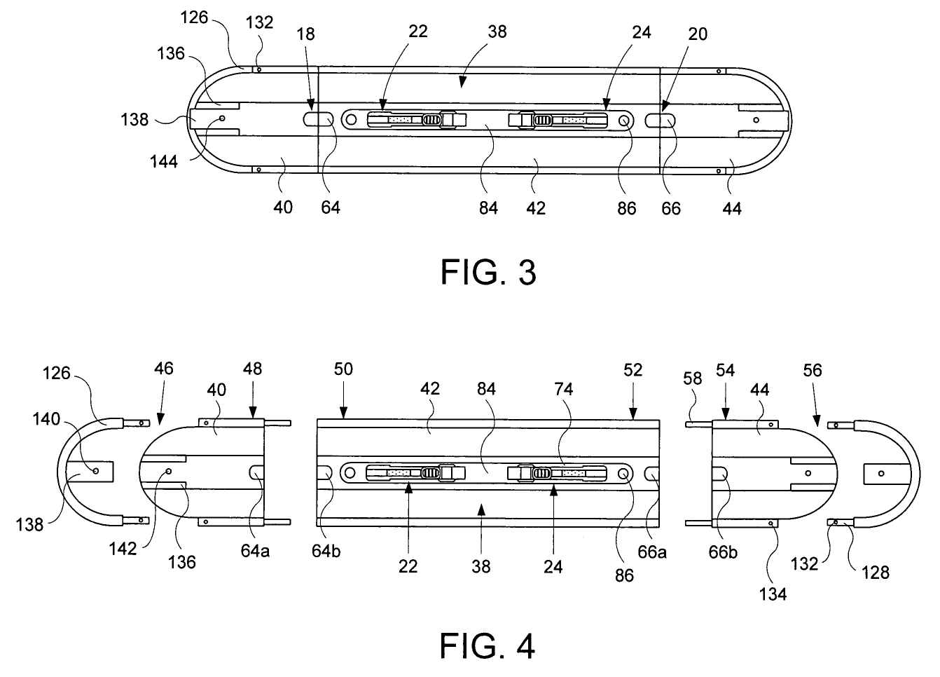

In the preferred embodiments of the skateboard 10 of the present invention, pins 58 and sockets 60 described above are utilized merely to guide adjoining sections of deck 12 together. The cooperatively configured truck mounting assemblies and mounting mechanisms, such as first truck mounting assembly 14 and first mounting mechanism 18, are utilized to attach the respective truck assemblies 26 to deck 12 and maintain the separate sections of deck 12 in their abutting relationship so as to form a unified deck 12. In the preferred embodiment, first 18 and second 20 mounting mechanisms each comprise an outwardly projecting truck mount connector, such as first truck mount connector 64 and second truck mount connector 66, attached to bottom surface 38 of deck 12, as best shown in FIG. 3. As set forth below, truck mount 28 of each of first 14 and second 16 truck mounting assemblies is configured to engage first 64 and second 66 truck mount connectors, respectively, to removably mount truck assemblies 26 to deck 12. For a one-piece deck 12, first 64 and second 66 truck mount connectors will generally be a single component. For the preferred embodiment, with deck 12 in multiple sections such as shown in FIG. 4, first 64 and second 66 truck mount connectors are provided in multiple components, such as 64a at second end 48 of first end section 40 and 64b at first end 50 of center section 42 for first mounting mechanism 18 and 66a at second end 52 of center section 42 and 66b at first end 54 of second end section 44 for second mounting mechanism 20. In this manner, when first 40 and second 44 end sections are joined to center section 42, truck mount components 64a and 64b will be abutting to form first truck mount connector 64 and truck mount components 66a and 66b will be abutting to form second truck mount connector 66. In the preferred embodiment, truck mount 28 of first truck mounting assembly 14 will mount to first truck mount connector 64 and second truck mounting assembly 16 will mount to second truck mount connector 66 in a manner that cooperatively engages truck mount 28 so as to hold first end section 40 to center section 42 and center section 42 to second end section 44 to form the unified deck 12.

In the preferred embodiments of the present invention, first 14 and second 16 truck mounting assemblies cooperatively engage first 18 and second 20 mounting mechanisms, respectively, through a twist-and-lock type of connection. To provide this type of connection, each truck mount 28 of first 14 and second 16 truck mount assemblies has a mounting cavity 68 with one or more receiving lips 70, best shown in FIG. 8, and each of first 64 and second 66 truck mount connectors have one or more projecting lips 72. In the embodiment shown in FIG. 8, mounting cavity 68 has a pair of opposite disposed receiving lips 70 and each of first 64 and second 66 truck mount connectors have a pair of opposite disposed projecting lips 72. Mounting cavity 68 truck mount 28 is sized and configured to receive first 64 or second 66 truck mount connectors therein, depending on whether it is first 14 or second 16 truck mounting assembly. As known to those familiar with twist-and-lock operation, mounting cavity 68 is configured to be placed over first 64 or second 66 truck mount connectors at a right angle to the normal, mounted direction and then first 14 or second 16 truck mounting assembly is twisted to place the assemblies in the correct direction such that projecting lips 72 of first 64 or second 66 truck mount connectors engage receiving lips 70 of mounting cavity 68 on truck mount 28 by receiving lips 70 slidably moving under projecting lips 72. Receiving lips 70 and projecting 72 should be configured such that receiving lips 70 of mounting cavity 68 are securely engaged by projecting lips of first 64 or second 66 truck mount connectors to tightly abut the sections of deck 12 together and hold first 14 and second 16 truck mounting assemblies on bottom surface 38 of deck 12.

The twist-and-lock configuration described above can be configured to be generally sufficient to hold deck 12 in one piece and to mount first 14 and second 16 truck mounting assemblies on bottom surface 38 of deck 12. To better ensure that first 14 and second 16 truck mount assemblies stay in place on bottom surface 38 of deck 12, however, the preferred configuration of this embodiment comprises a secondary locking or securing mechanism, best shown on FIGS. 2 through 4 as first securing mechanism 22 and second securing mechanism 24. Preferably, each of the first 22 and second 24 securing mechanisms comprise a securing assembly 74 attached to bottom surface 38 of deck 12 and an outwardly extending member 76 on first 14 and second 16 truck assemblies. As set forth below, outwardly extending member 76 should be configured to be sufficiently resilient to facilitate secure engagement with securing assembly 74. In one embodiment, outwardly extending member 76 is made out of a polycarbonate material or other plastic, composite or metal materials. In the embodiment shown in FIGS. 7 and 8, outwardly extending member 76 is generally configured as an L- or J-shaped member having an upper surface 78 and a lower surface 80 with a locking projection 82 thereon. This embodiment also utilizes a securing assembly 74 comprising securing base member 84 that is securely mounted to bottom surface 38 of deck 12 which has a locking cavity 86 near the end thereof, as best shown in FIG. 3. In the embodiment shown, locking projection 82 is a raised area of lower surface 80 of outwardly extending member 76 and locking cavity 86 is an aperture through base member 84. As explained in more detail below, locking projection 82 and locking cavity 86 should be cooperatively configured such that locking projection 82 will securely fit within locking cavity 86. In the preferred embodiment, the resilient nature of outwardly extending member 76 facilitates the engagement of locking projection 82 inside locking cavity 86 by allowing the user to push outwardly extending member 76 toward bottom surface 38 of deck 12 such that locking projection 82 can be rotated under base 84 until it is generally aligned with locking cavity 86, when the resilient nature of outwardly extending member 76 will push locking projection 82 into locking cavity 86.

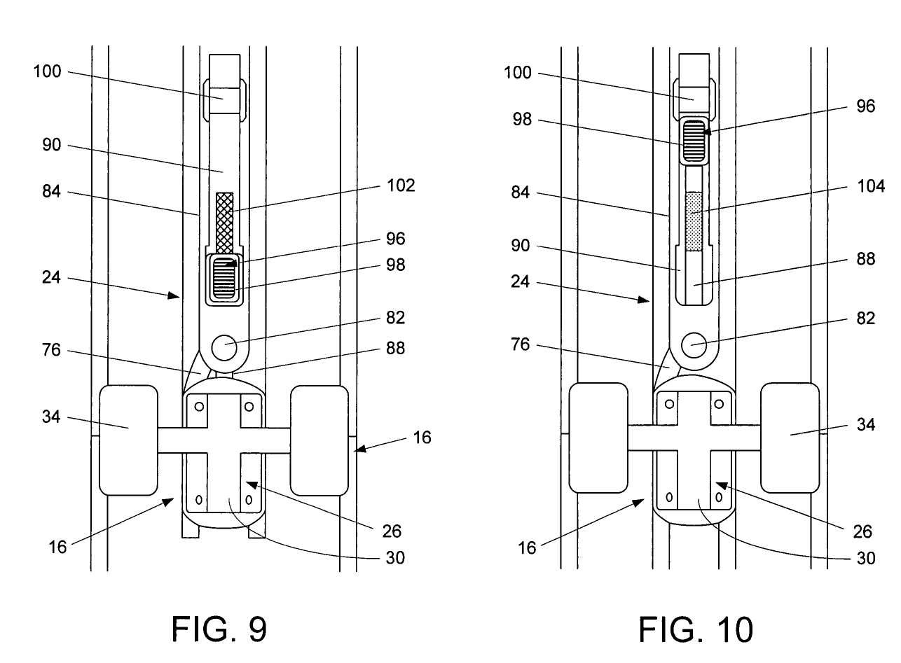

A preferred configuration of the skateboard 10 of this embodiment of the present invention also has an additional securing mechanism as part of first 22 and second 24 securing mechanisms, shown in FIGS. 2 through 4 and 9 through 12, to further ensure that first 14 and second 16 truck mounting assemblies are secured to the bottom surface of deck 12. This additional securing mechanism also utilizes base member 84 to slidably dispose securing extension member 88, best shown in FIGS. 10 through 12, toward first 14 or second 16 truck mounting assemblies. Securing extension member 88 is configured to slide in extension channel 90 of base member 84 so that extension member 88 can engage locking aperture 92 on a side 94 of truck mount 28 (shown in FIG. 7) to better secure first 14 or second 16 truck mounting assemblies to bottom surface 38 of deck 12. As shown in FIG. 9, securing extension member 88 slides under outwardly extending member 76 to prevent locking projection 82 from being disengaged from locking cavity 86. In one embodiment, extension member 88 slidably engages the upper surface 78 of outwardly extending member 76 to help displace locking projection 82 into locking cavity 86. A securing latch 96 generally at the end of securing extension member 88 is utilized to lock securing extension member 88 inside locking aperture 92 when it is desired to secure first 14 or second 16 truck mounting assemblies to deck 12. In the configuration shown in FIGS. 9 through 12, securing latch 96 is configured with a thumb or finger push plate 98 to assist the user with moving securing latch 96, and therefore securing extension member 88, from the locked condition (shown in FIG. 9) to the unlocked condition (shown in FIGS. 10 through 12) to disengage securing extension member 88 from locking aperture 92 so that first 14 or second 16 truck mounting assembly can be removed from deck 12. An enlarged portion of channel 90 is configured to receive push plate 98 such that it moves outwardly and cannot move into the narrow portion of channel 90 unless force, typically the user's thumb or finger, is applied to push plate 98 in the enlarged portion of channel 90 to allow securing latch 96 to be moved away from first 14 or second 16 truck mounting assembly, thereby disengaging extension member 88 from locking aperture 92. In this manner, it is unlikely that securing latch 96 will be accidently moved and extension member 88 inadvertently disengaged from locking aperture 92. Stop member 100 is utilized to stop the movement of securing latch 96 and extension member 88 past the point necessary to disengage extension member 88 from locking aperture 92.

To assist the user in recognizing whether the first 14 and/or second 16 truck mounting assemblies are secured by extension member 88, the preferred embodiment of the present invention utilizes a locked indicator 102 and an unlocked indicator 104. In the preferred embodiment, locked indicator 102 is located in channel 90 of base member 84 below the slidable extension member 88 and securing latch 96 and is not exposed unless push plate 98 of securing latch 96 is disposed in the enlarged portion of channel 90 and extension member 88 is engaged in locking aperture 92. When securing latch 96 is moved in channel 90 to disengage extension member 88 from locking aperture 92, locked indicator 102 will be covered up by extension member 88 and unlocked indicator 104, which is disposed on extension member 88, will become visible to warn the user that first 14 or second 16 truck mounting assembly is not secured by extension member 88. In one embodiment, locked indicator 102 is a patch or spot of green color and unlocked indicator 104 is a patch or spot of red color.

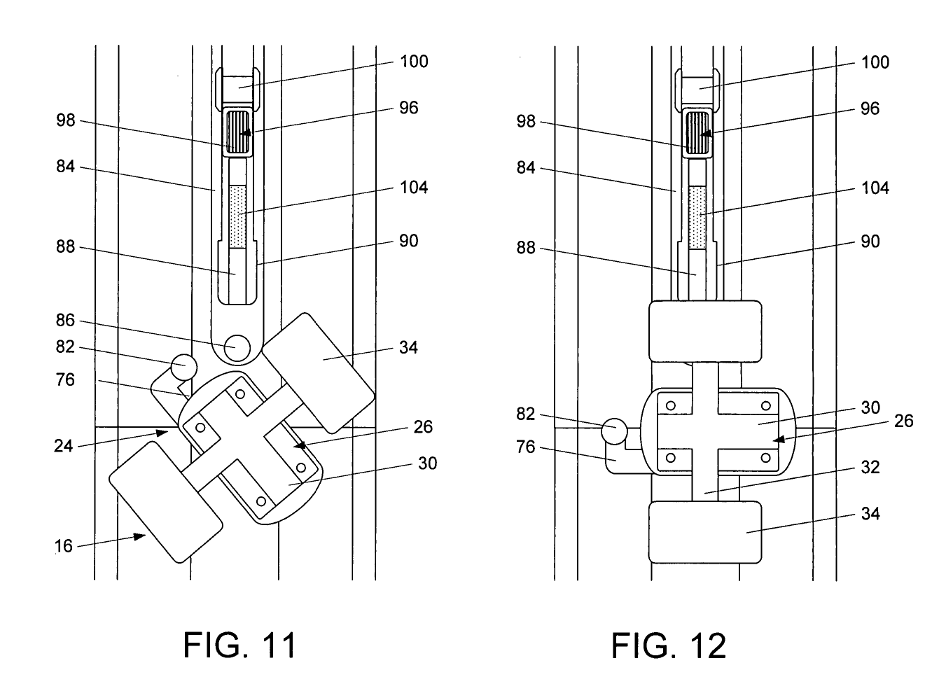

The operation of skateboard 10 of the preferred embodiment set forth above is shown in sequence, from locked condition to the unlocked ready to be removed condition, in FIGS. 9 through 12. In FIG. 9, second securing mechanism 24 is shown in the engaged or locked condition with truck mount 28 of second truck mounting assembly 16 mounted on second mounting mechanism 22 (not shown in FIG. 9) utilizing the twist-and-lock configuration described above, locking projection 82 of outwardly extending member 76 is engaged in locking cavity 86, securing latch 96 is at the enlarged portion of the channel 90 in base member 84, and extension member 88 is engaged inside locking aperture 92 of truck mount 28. Locked indicator 102 (i.e., a green colored area) is visible so as to indicate to the user that second securing mechanism 24 is in the secured or locked condition. As such, skateboard 10 is ready for riding or other use as, effectively, a single integral skateboard. In FIG. 10, securing latch 96 has been moved from the enlarged portion of channel 90, by pushing down on and sliding push plate 98, to a position at or near stop member 100 so as to withdraw or disengage extension member 88 from locking aperture 92. The locked indicator 102 (i.e., a red colored area) is covered by extension member 88 and the unlocked indicator 104 is displayed to indicate to the user that second securing mechanism 24 is not engaged. In FIG. 11, locking projection 82 on outwardly extending member 76 is disengaged from locking cavity 86, accomplished by pushing down on and twisting second truck mounting assembly 16, so as to begin the process of removing second truck mounting assembly 16 and truck assembly 26 from second mounting mechanism 22 (also not shown in FIG. 11). In this condition, receiving lips 70 of mounting cavity 68 on truck mounting assembly 16 are still partially engaged with projecting lips 72 on second truck mount connector 66, thereby preventing the complete removal of second truck mounting assembly 16 from deck 12. In FIG. 12, truck mount 28 of second truck mounting assembly 16 is completely twisted around on second truck mount connector 66 such that second truck mounting assembly 16 is ready to be removed from bottom surface 38 of deck 12. Once second truck mounting assembly 16 is lifted off of and removed from second truck mount connector 66, first end 54 of second end section 44 can be separated from second end 52 of center section 42. This same sequence is repeated for first truck mounting assembly 14 to separate first end section 40 from center section 42, thereby making it easier for the user to store and carry skateboard 10.

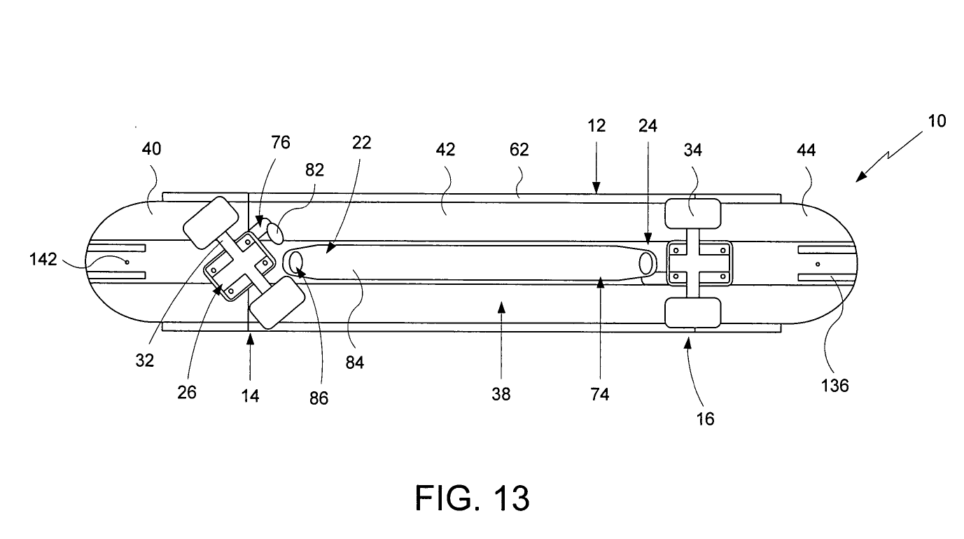

An alternative embodiment of the present invention is shown in FIG. 13. In this embodiment, most of the same features described above are also utilized. For instance, the same twist-and-lock arrangement are utilized for first 14 and second 16 truck mounting assemblies to mount to the first 18 and second 20 mounting mechanisms (not shown in FIG. 13) described above. Outwardly extending member 76 is basically configured the same except it has a generally oval shaped locking projection 82 that is shaped and configured to fit within like configured locking cavity 86, as shown for second truck mounting assembly 16. In this embodiment, securing assembly 74 comprises securing base member 84 with a locking cavity 86 at each end. The additional securing mechanism of the slidable extension member 88, used to more securely engage locking projection 82 in locking aperture 86, is not utilized in this embodiment. Likewise the locked 102 and unlocked indicators are also not utilized. As described above for the previous embodiment, deck 12 can be a single piece or it can comprise two or more deck sections, such as the three deck sections shown, for easier carrying and storage.

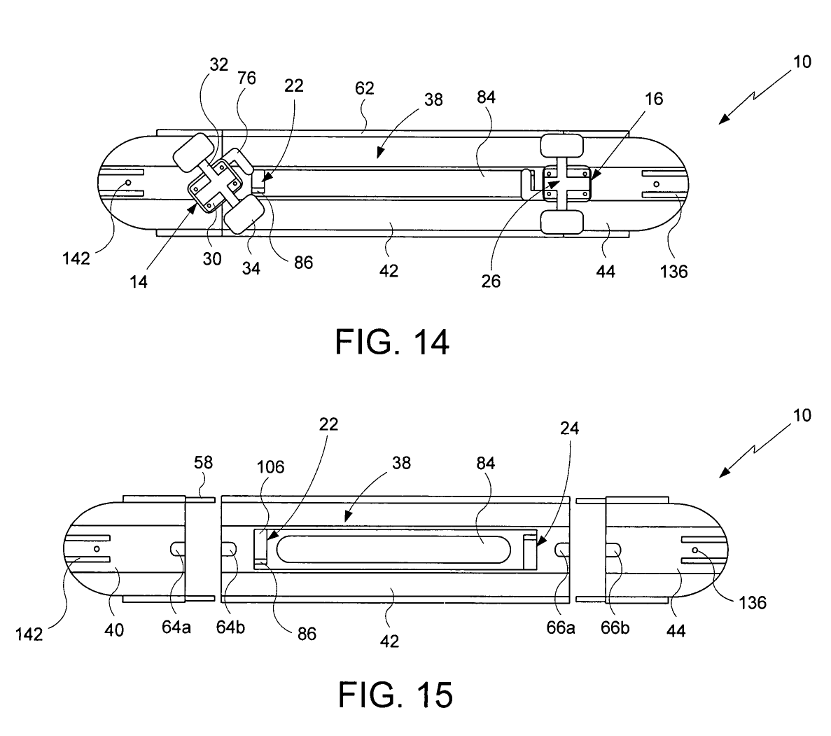

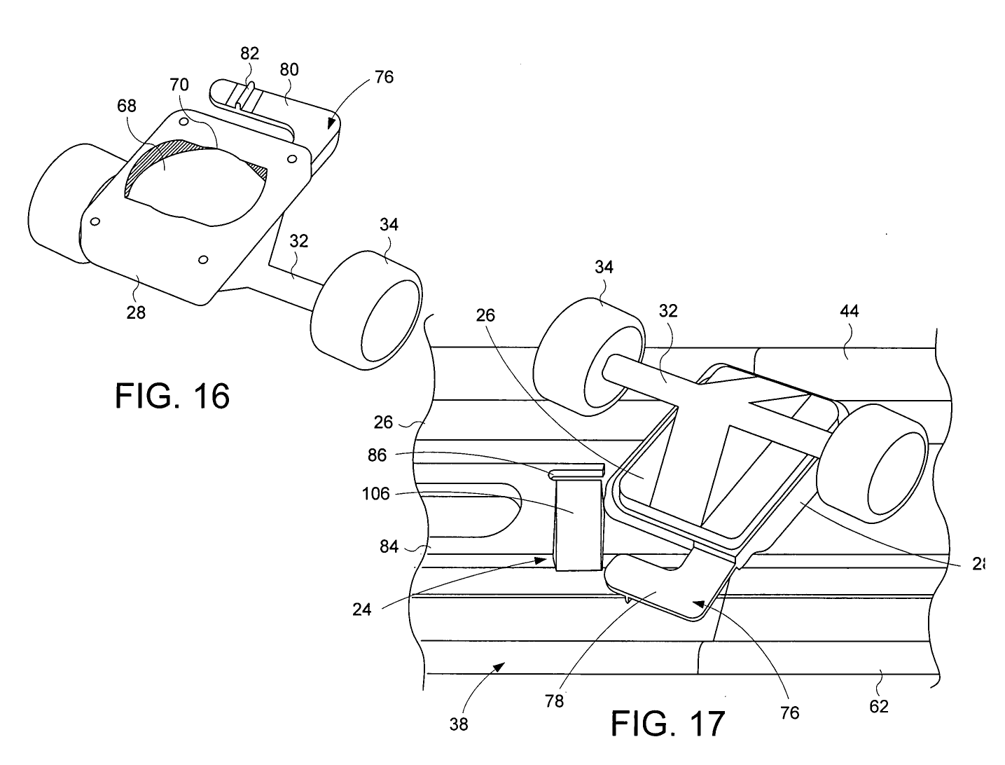

Another alternative embodiment is shown in FIGS. 14 through 17. In this embodiment, first 14 and second 16 truck mounting assemblies mount to first 18 and second 20 mounting mechanisms (not specifically shown), respectively, using the same twist-and-lock arrangement described in the above embodiments to mount to bottom surface 38 of deck 12 and to join first end section 40 to center section 42 and second end section 44 to center section 42. This embodiment also utilizes the outwardly extending member 76 attached to truck mount 28 having mounting cavity 68 configured to receive first 64 or second 66 mount connectors (shown in FIG. 15 as components 64a, 64b, 66a and 66b) therein for engagement of receiving lips 70 and projecting lips 72 to accomplish the “lock” part of the twist-and-lock arrangement. The difference with this embodiment is the configuration of first 22 and second 24 securing mechanisms, the placement of locking projection 82 and the manner in which locking projection 82 engages locking cavity 86. As best shown in FIGS. 16 and 17, in this embodiment locking projection 82 is located on the lower surface 80 of outwardly extending member 76 (instead of the upper surface 78, which can be generally planar in this embodiment) and first 22 and second 24 securing mechanisms have a ramp section 106 configured to direct outwardly extending member 76 toward locking cavity 86 for engagement with locking projection 82 therein. Ramp section 106 is an inclined section of securing base member 84 that takes advantage of the flexible or resilient nature of outwardly extending member 76 to obtain the engagement between truck mount 28 and first 22 or second 24 securing mechanisms. In use, as the user twists the first 14 or second 16 mounting assembly on first 64 or second 66 truck mount connector the locking projection 82 on outwardly extending member 76 will make contact with ramp section 106 of base member 84. As the first 14 or second 16 mounting assembly is twisted toward its engagement with first 18 or second 20 mounting mechanisms, the contact between locking projection 82 and ramp section 106 flexes or lifts outwardly extending member 76 until locking projection 82 drops into locking cavity 86, thereby preventing further rotation of first 14 or second 16 mounting assembly without first disengaging locking projection 82 from locking cavity 86. The flexible or resilient nature of outwardly extending member 76 will provide force to maintain engagement of locking projection 82 in locking cavity 86. At the same time, receiving lips 70 of mounting cavity 68 are engaged with projecting lips 72 of first 64 or second 66 truck connectors, thereby mounting first 14 or second 16 mounting assemblies on deck 12 and joining deck sections 40, 42 and 44 together to form a unified deck 12. The engagement of locking projection 82 in locking cavity 86 prevents further twisting (i.e., dismounting) of first 14 or second 16 mounting assemblies. For typical riding on skateboard 10, the above described engagement of locking projection 82 in locking cavity 86, as well as the twist-and-lock connection of first 14 or second 16 mounting assemblies, should be sufficient to maintain skateboard 10 in its assembled condition. If skateboard 10 is to be used for jumps, spins or other tricks it may be beneficial to include the additional securing mechanism described above with regard to the use of extension member 88 and its engagement with locking aperture 92 on truck mount 28.

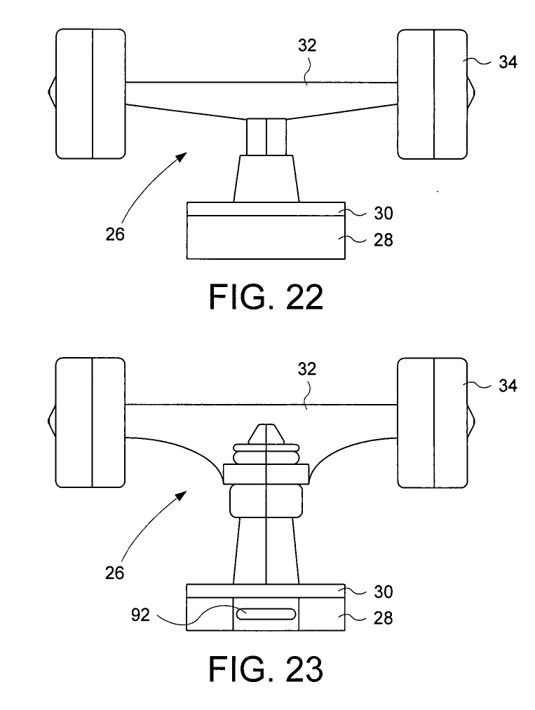

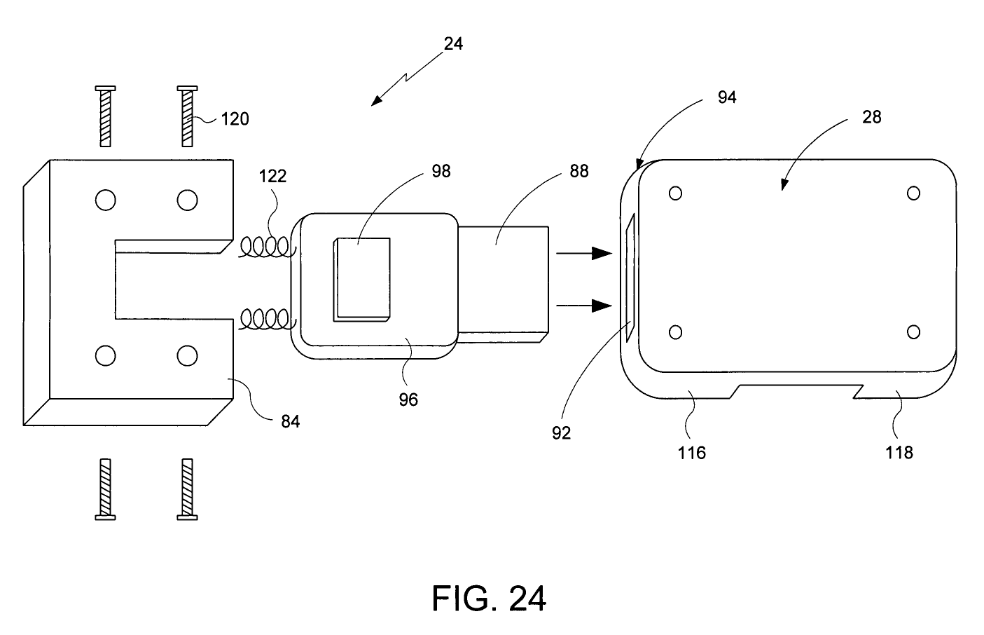

Yet another embodiment of the skateboard 10 of the present invention is set forth in FIGS. 18 through 24. In this embodiment, pins 58 are positioned towards the centerline of deck 12, as opposed to being at the edges 62 of deck 12, and configured to be generally rectangular in cross-section to function as support tabs. Pins 58 are secured in a cavity of first 40 and second 44 end sections and secured in place by tab plates 108 secured to bottom surface 38 of deck 12 with a plurality of connecting elements, such as screws, bolt, rivets, adhesive and the like. Socket 60 is formed from a cavity at the first end 50 and second end 52 of center section 42 and supported by socket plates 110 so that pins or tabs 58 may be slidably received in socket 60 to form the unified deck 12 from deck sections 40, 42 and 44, much the same way as described in the embodiments above. In this embodiment, both first 18 and second 20 mounting mechanisms and first 22 and second 24 securing mechanisms are configured differently than described above. As best shown in FIGS. 20 and 21, first 18 and second 20 mounting mechanisms each comprise a first deck receptacle 112 and a second deck receptacle 114 on bottom surface 38 of deck 12 that are configured to engagedly receive, respectively, a first bracket extension 116 and a second bracket extension 118 which extend outwardly from truck mount 28, as best shown in FIG. 21. Preferably, first 112 and second 114 deck receptacles are shaped and configured such that when first 116 and second 118 bracket extensions are received therein, first 14 and second 16 mounting assemblies will be generally stable on deck 12 and, if deck 12 is provided in multiple sections (such as deck sections 40, 42 and 44), hold the deck sections together to form the unified deck 12. To secure first 14 or second 16 mounting assemblies to bottom surface 38 of deck 12 and the sections of deck 12 together, securing assembly 74 of first 22 and second 24 securing mechanisms of this embodiment comprises securing latch 96 having an extension member 88 thereon that is configured to be at least partially received in locking aperture 92 on truck mount 28, as best shown in FIG. 24, in much the same manner as described above. Securing latch 96 is configured to be slidably engaged by securing base member 84 such that extension member 88 can be slid toward base member 84 to disengage from locking aperture 92 so as to allow the user to remove first 14 or second 16 mounting assembly from deck 12. In a preferred embodiment, base member 84 forms a housing with one side, the side facing the truck mount 28, open to allow securing latch 96 to slidably move relative to base member 84. Base member 84 can be secured to bottom surface 38 of deck 12 with one or more connecting elements, such as screws 120 shown in FIG. 24, or by use of adhesive, welding or other appropriate mechanisms. In the preferred configuration of this embodiment, one or more springs 122 are disposed between base member 84 and securing latch 96 to bias securing latch 96, and therefore extension member 88, towards locking aperture 92 of truck mount 28 so that it may be engaged therein to prevent first 14 or second 16 mounting assembly from being inadvertently or unintentionally disengaged from deck 12. To remove first 14 or second 16 mounting assembly from deck 12, the user pushes against push plate 98 to move securing latch 96 with sufficient force to overcome springs 122 and slide extension member 88 out of locking aperture 92 on truck mount 28.

For each of the above-described embodiments, it is preferred that skateboard 10 be made out of materials that are lightweight to reduce the burden on the user when carrying skateboard 10 in a backpack or other carrying case and sufficiently durable, strong and corrosion resistant for use as a skateboard 10. In a preferred embodiment, most of the components are made out of a lightweight, strong metal, such as aluminum and the like, with outwardly extending member made out of sufficiently resilient plastic, such as the polycarbonate material described above. Truck assembly 26 can be configured and made out of materials commonly utilized for presently available skateboards, including the various materials which are known to be desirable for wheels 34. To further reduce the weight of skateboard 10, the preferred embodiment of deck 12 has one or more reduced mass areas 124, such as the three hash mark areas shown in FIG. 20. The areas shown as reduced mass areas 124 can have material removed from the thickness of deck 12 in a manner that reduces the weight of deck 12 without substantially reducing the strength of deck 12. The material for reduced mass areas 124 can be removed by routing or other means appropriate for the materials utilized for deck 12.

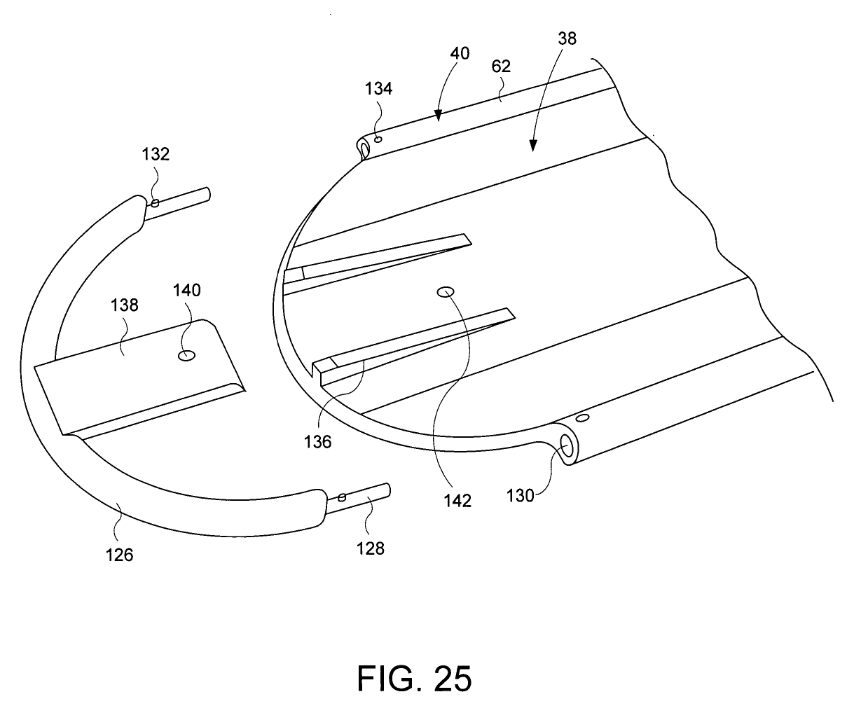

The preferred embodiment of skateboard 10 of the present invention also utilizes bumper guards 126 at the opposing ends of deck 12, shown as first end 46 of first end section 40 and second end 56 of second end section 44 in the figures (i.e., FIGS. 1 through 4). In the preferred embodiment, as shown in FIG. 4, bumper guards 126 are removable from deck 12 so the user can replace them as needed or desired due to damage or upgrading. In a preferred embodiment, bumper guards 126 are made out of polyethylene or other plastic materials and are shaped and configured to tightly abut the ends 46 and 56 of deck 12. To secure bumper guards 126 to deck 12, a pin and socket connection is used (which is similar to that utilized to connect the deck sections together). As shown in FIG. 25, bumper pin 128 is configured to fit within bumper socket 130 so as to guide bumper guard 126 against the ends 46 and 56 of deck 12. To prevent bumper guards 126 from falling off or being knocked off, it is preferred that bumper guards 126 be secured to deck 12 with one or more bumper securing mechanism, such as those shown in FIG. 25. In one configuration, bumper pin 128 is provided with a bumper locking projection or protrusion 132 that is received in and engaged by bumper aperture 134 that is in communication with bumper socket 130 such that when bumper pin 128 is received in bumper socket 130, bumper projection 132 will be received in bumper aperture 134 to hold bumper guard 126 tightly against ends 46 and 56 of deck 12. To assist with guiding and securing bumper guard 126 into place, the bottom surface 38 of deck 12 has a pair of bumper guides 136 and bumper guard 126 has an outward extending guide member 138 sized and configured to fit within bumper guides 136. To further secure bumper guard 126 to deck 12, guide member 138 has a first bumper hole 140 and bottom surface 38 has a correspondingly positioned second bumper hole 142 configured such that when bumper guard 126 is in place, with guide member 138 disposed between the pair of bumper guides 136, first bumper hole 140 is vertically aligned with second bumper hole 142 such that a screw or other connecting element, shown as 144 in FIGS. 2 and 3, can be inserted therein to secure guide member 138 to bottom surface 38 of deck 12 (i.e., first deck section 40 is shown in FIG. 25) to better secure bumper guard 126 to ends 46 and 56 of deck 12. As will be known to those skilled in the art, various other configurations are available for removably attaching bumper guards 126 to deck 12, including making bumper guards 126 integral with deck 12.

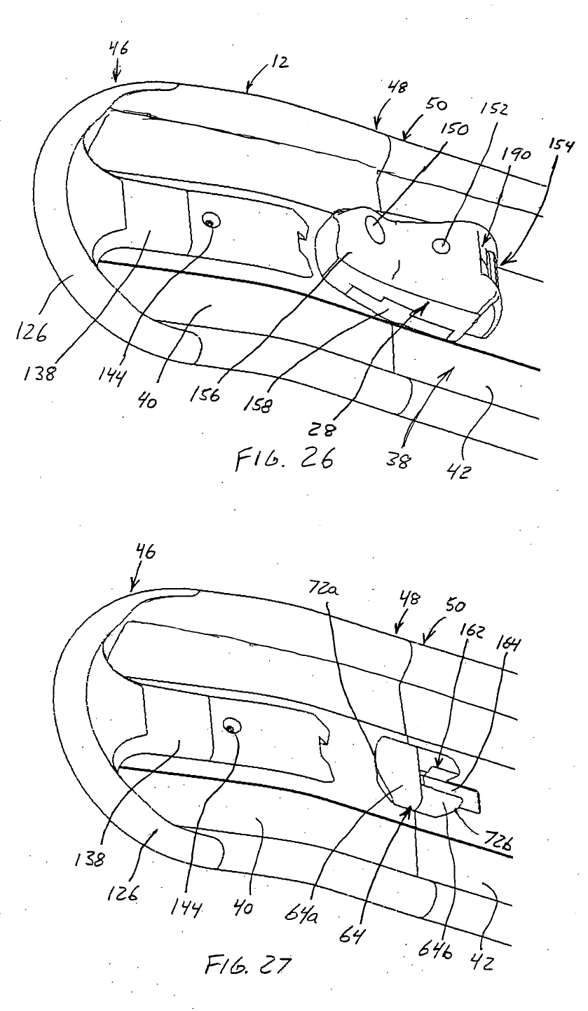

A more preferred embodiment of the skateboard 10 of the present invention is shown in FIGS. 26 through 31. As with the above-described embodiments, truck mount 28 can be utilized to securely join two sections, such as first end section 40 and center section 42 shown in FIGS. 26 and 27, together to form a substantially unitary deck 12 for skateboard 10. Although the present embodiment utilizes the pin and socket arrangement, as best shown in FIGS. 5 and 6, to guide adjacent sections together in an abutting relationship and the bumper assembly shown and described in conjunction with FIG. 25 to protect the forward and rearward ends of the deck 12, those skilled in the art will recognize that other mechanisms that guide or join two sections together or bumper assemblies, such as the alternatives to these mechanisms/assemblies described above, can also be utilized with the preferred embodiment shown in FIGS. 26 through 31. As also described in one or more embodiments above, the present embodiment can be utilized with a one-piece deck 12 that has one or more truck mount connectors, such as a connector similar to first 64 and second 66 truck mount connectors shown in and discussed in conjunction with FIGS. 3 through 6, on the bottom surface 38 thereof. The improvement to this embodiment is the configuration of truck mount 28 and its interaction with the truck mount connector 64/66 of deck 12 that are used to secure truck mount 28 to deck 12. In FIGS. 26 through 31, truck mount 28 is shown without its associated truck assembly 26, which connects to truck mount 28 at the truck mounting apertures 150 and 152, best shown in FIGS. 26 and 28. As set forth above, a variety of truck assemblies 26 (not shown in FIGS. 26 through 31) can be utilized with truck mount 28 of the preferred embodiment, with truck mounting apertures 150 and 152 being positioned and configured accordingly. In addition, as also set forth above, truck assembly 26 can be made integral with truck mount 28 or be attached thereto by use of adhesives or other connecting materials or mechanisms.

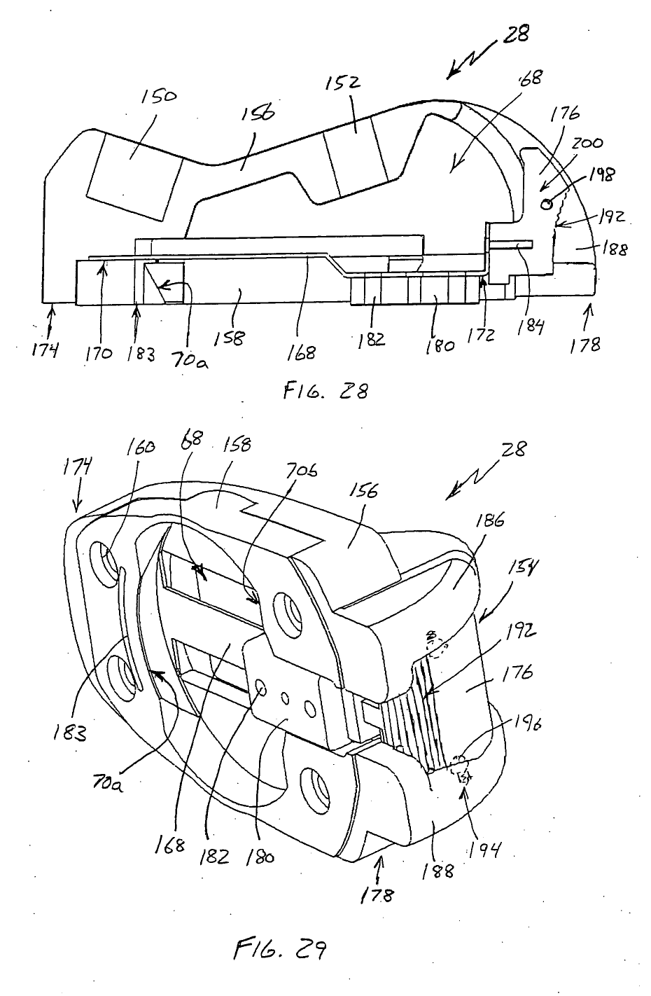

In the embodiment of FIGS. 26 through 36, truck mount 28 comprises a latching mechanism 154 configured to cooperate with a modified truck mount connector, such as first truck mount connector 64 shown, to directly secure truck mount 28 to the bottom surface 38 of deck 12 without utilizing an external securing mechanism, such as 22 and 24 shown in FIGS. 2 through 4, or the outwardly extending member 76 and locking projection 82 shown in these same figures. Instead, as set forth in more detail below, the securing mechanism of the preferred embodiment is built into truck mount 28 as latching mechanism 154 in order to simplify the installation and removal of the truck mounting assembly (i.e., the combined or joined truck assembly 26 and truck mount 28) from deck 12. Latch mechanism 154, in conjunction with mount body 156 and mount base 158, is configured to securely engage a truck mount connector, such as first truck mount connector 64 (hereinafter, references to first truck mount connector 64 or truck mount connector 64 are intended to apply equally to second truck mount connector 66 shown in the figures for other embodiments), as modified for the present truck mount 28. Although mount body 156 and mount base 158 can be made integral with each other, it is preferred that these two components be separately manufactured and then joined together to form a substantially unitary truck mount 28 with a portion of the latching mechanism disposed therebetween (as set forth below). This allows the mount body 156 and mount base 158 to be manufactured out of different materials, each more suitable for its intended function. For instance, mount body 156 can be made out of aluminum or other relatively strong metal or composite material to connect to the truck assembly 26 and mount base can be formed out of a plastic, such as delron or nylon, or a composite material that is more suitable for forming into the desired shape. As shown in FIG. 29, mount base 158 can comprise one or more mounting apertures 160, such as the four shown, for receiving a screw or other connector to join mount base 158 to mount body 156.

As set forth above, truck mount 28 is configured to engage first truck mount connector 64 to removably mount the truck assembly 26 to deck 12 to form a functioning skateboard 10. For a one-piece deck 12, the truck mount connector 64 will generally be a single, integral component. For the preferred embodiment, with deck 12 in multiple sections such as best shown in FIG. 4, first truck mount connector 64 is provided in multiple components, such as a first component 64a at the second end 48 of the first end section 40 and a second component 64b at the first end 50 of center section 42. In this manner, when first 40 end section is joined to center section 42, truck mount components 64a and 64b will be in abutting relation to define first truck mount connector 64. In the preferred embodiment, truck mount 28 will mount to first truck mount connector 64 in a manner that cooperatively engages truck mount 28 so as to securely join first end section 40 to center section 42, with the pin/socket or other mechanism being used to primarily guide the adjoining section 40 and 42 together, so as to provide a unified deck 12 for skateboard 10. In the preferred configuration of this embodiment, truck mount 28 and truck mount connector 64 are cooperatively configured to enable truck mount 28 to engage truck mount connector 64 in the twist-and-lock type of connection previously described.

To achieve the desired twist-and-lock connection, truck mount connector 64 has a mounting cavity 68 having first receiving lip 70a and second receiving lip 70b, best shown in FIG. 29, that cooperatively engage, respectively, first projecting lip 72a at first component 64a and a second projecting lip 72b at second component 64b, best shown in FIG. 27. As shown, first projecting lip 72a and second projecting lip 72b extend outwardly from truck mount connector 64 in opposite directions. Mounting cavity 68 of truck mount 28 is sized and configured to receive first truck mount connector 64 therein. As known to those familiar with twist-and-lock operation, mounting cavity 68 of truck mount 28 is configured to be placed over the truck mount connector 64 at a right angle to the normal, mounted direction of truck assembly 26 and then be twisted to place the wheels 34 in the correct direction such that projecting lips 72a and 72b of truck mount connector 64 engages receiving lips 70a and 70b, respectively, of truck mount 28 by the receiving lips 70a and 70b slidably moving under projecting lips 72a and 72b. Receiving lips 70a and 70b and projecting lips 72a and 72b should be somewhat cooperatively configured such that receiving lips 70a and 70b of mounting cavity 68 are securely engaged by projecting lips 72a and 72b of first truck mount connector 64 to tightly abut the first end 40 and center 42 sections of deck 12 together and hold the truck mounting assembly on the bottom surface 38 of deck 12 to form a substantially unified skateboard 10.

The twist-and-lock configuration described above can be configured to be sufficient, on its own, to hold deck 12 in one piece and to mount the first 14 and second 16 truck mounting assemblies on bottom surface 38 of deck 12. To better ensure that these truck mount assemblies stay in place on bottom surface 38 of deck 12, however, the preferred configuration of the truck mount 28 of this embodiment comprises a locking or securing mechanism that is configured to cooperate with truck mount connector 64. In the preferred embodiment of this securing means, truck mount connector 64 has a cut-out section 162 in second component 64b that defines a slot 164 which, in the preferred embodiment, extends into the bottom surface 38 of deck 12 as shown in FIG. 27. As explained in more detail below, truck mount 28 is configured to slide over truck mount connector 64 and cooperatively engage the cut-out section 162 and slot 164 in order to secure truck mount 28, and the associated truck assembly 26, to deck 12 so as to form a generally integral skateboard 10. To facilitate the movement of truck mount 28 over truck mount connector 64 and its engagement with slot 164, the sides of truck mount connect 64 should be sloped upward from the bottom surface 38 of deck 12. Typically, this slope will only need to be a gentle slope that facilitates the movement of the securing mechanism of truck mount into the cut-out section 162 and slot 164.

As best shown in FIGS. 28 and 29, truck mount 28 of the present embodiment comprises mounting cavity 68 defined by mount body 156 in which is operatively disposed latching mechanism 154. As shown, latching mechanism 154 comprises an elongated spring member 168 having a first end 170 and a second end 172 that is disposed between mount body 156 and mount base 158 at its first end 170 near the first end 174 of truck mount 28, a guide member 176 at second end 172 of spring member 168 that is positioned near the second end 178 of truck mount 28 and an engagement member 180 attached to the spring member 168 near the guide member 176. In the preferred embodiment, spring member 168 has on or more apertures 181 that align with apertures 160 in mount base 158 so as to secure spring member 168 between mount base 158 and mount body 156 by the screws or other connectors used to attach mount base 158 to mount body 156. Spring member 168 is preferably manufactured out of a spring metal material such that, with its first end 170 secured between mount body 156 and mount base 158, it has sufficient flexibility to be directed upward into mounting cavity 68 when truck mount 28 is twisted onto truck mount connector 64. As described above with a previous embodiment, the width of mounting cavity 68 is sufficient to extend over the length of mount connector 64 for installation of truck mount 28 on to deck 12 and its removal therefrom.

The engagement member 180 is attached to spring member 168 such that the upward movement of spring member 168 from its contact against truck mount connector 64 will move engagement member 180 upward so that it may slide across the top of truck mount connector 64 to the slot 164. In the embodiment shown, one or more screws 182 are used to attach engagement member 180 to spring member 168. As will be readily understood by those skilled in the art, however, spring member 168 and engagement member 180 can be integrally formed or various other mechanisms, including adhesives, welding, bolts or other means for connecting these two components together can also be utilized. Engagement member 180 is shaped and configured to fit within the slot 164 defined by cut-out section 162 and securely hold, along with the receiving lips 70 and projecting lips 72, truck mount 28 on truck mount connector 64. In the preferred embodiment, engagement member 180 tightly fits into slot 164 to prevent any wobbling or other undesirable movement of truck mounting assembly 14/16 when attached to deck 12. When truck mount 28 is placed on truck mount connector 64 and then twisted or rotated into position, the receiving of engagement member 180 into cut-out section 162 and slot 164 prevents further rotation of truck mount 28, thereby preventing any unintended and undesirable disengagement of truck mount 28, and therefore truck mounting assembly 14/16, from deck 12. Preferably, mount base 158 is provided with a relief cut 183, best shown in FIG. 29, near the first end 174 of truck mount 28 to allow give in the material for mount base 158 when truck mount 28 is mounted on truck mount connector 64.

Guide member 176 is configured for controlled release of engagement member 180 from slot 164 and, therefore, truck mount 28 from truck mount connector 64. In the present embodiment, as best shown in FIGS. 28, 30 and 31, guide member 176 is attached to the second end 172 of spring member 168 with one or more connecting elements, such as screw 184. To facilitate this attachment, spring member 168 has an upwardly extending portion 186 at its second end 172 which abuts the back side of guide member 176. Alternatively, guide member 176 can be integral with second end 172 of spring member 168 or with upwardly extending portion 186. Guide member 176 is disposed between a pair of guide member supports 186 and 188, which define a guide cavity 190 (best shown in FIG. 26) at the second end 178 of truck mount 28 in a manner that allows guide member 176 to be slidably disposed therebetween. Because guide member 176 is attached or integral to the second end 172 of spring member 168, the upward sliding movement of guide member 176 in guide cavity 190 will pull spring member 168 and, therefore, engagement member 180, upward into mounting cavity 68. This upward movement of guide member 176 will remove engagement member 180 from the cut-out section 162 and slot 164 to allow the twisting or rotation of truck mount 28 so that it may be removed from truck mount connector 64. In the preferred embodiment, guide member 176 has a ridge section 192 with a plurality of ridges, as is familiar to those skilled in the art, that is contacted by the user with his or her thumb or finger to move guide member 176 upward to remove the mounting assembly 14/16 from deck 12.

As discussed above, while latching mechanism 154 can be configured to substantially secure truck mount 28 to truck mount connector 64 (and likewise for truck mount connector 66) without the need of additional securing mechanisms, it is preferred that a “back-up” or secondary securing mechanism also be utilized, such as shown in and described in conjunction with the embodiments of skateboard 10 of FIGS. 1 through 24. A preferred configuration for a truck mount securing mechanism or means is shown as 194 in FIGS. 28, 29 and 31. One advantage of the securing mechanism 194 is that the bottom surface 38 of deck 12 does not require any further components, such as the first 22 or second 24 securing mechanisms described above. In the present embodiment, truck mount securing mechanism 194 comprises a spring-driven ball 196 disposed in one or both of the guide member supports 186 and 188 that is configured to be received in a cooperatively positioned detent 198 on the sides 200 of guide member 176. Truck mount securing mechanism 194 is configured to bias ball 196 outward into guide cavity 190 when guide member 176 is not in its lowered, locked position. As guide member 176 is pushed downward by the user, the sides 200 of guide member 176 will push the ball 196 into guide supports 186/188 until the detent 198 is aligned with the position of ball 196, at which time the mechanism 194 will bias the ball 196 partially into detent 198 to effectively lock guide member 176 in place. Preferably, the movement of ball 196 into detent 198 is accomplished with a “click” action, as known to those in the art, that can be felt and/or heard by the user. As such, the installation of truck mount 28 onto deck 12 is a two-step process, the first being the placement and twisting of truck mount 28 onto truck mount connector 64 and the second being the downward push on guide member 176 to engage the truck mount securing mechanism 194. Once guide member 176 is pushed downward to engage ball 196 into detent 198, the guide member is locked in position, thereby holding engagement member 180 inside the cut-out section 162 and slot 164 of the truck mount connector 164 to prevent truck mount 28 from becoming disengaged from truck mount connector 64 when skateboard 10 is in use.

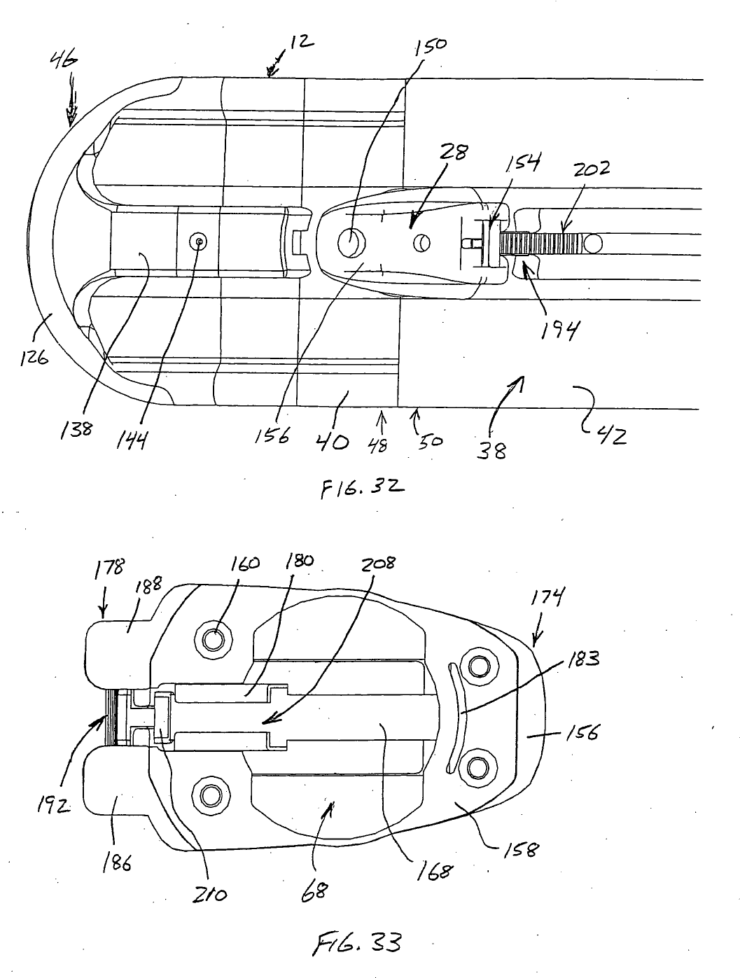

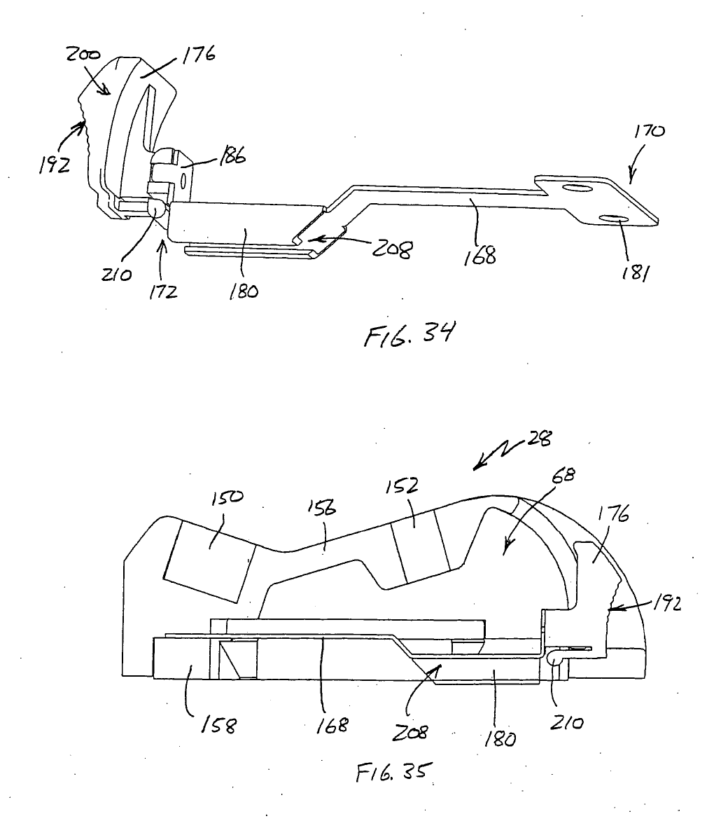

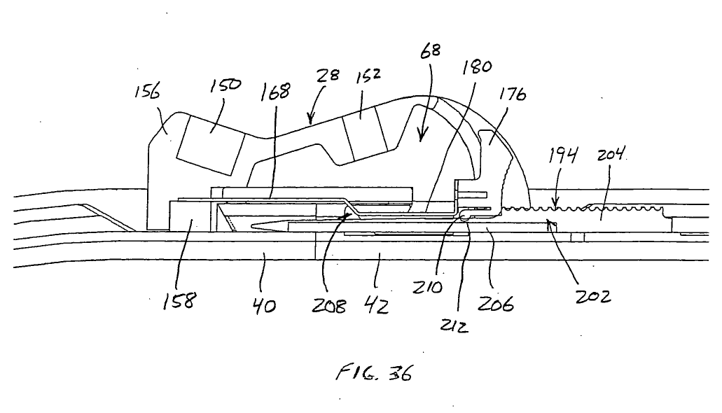

An alternative embodiment of truck mount securing mechanism 194, shown in FIGS. 32 through 36, comprises a slide mechanism 202 having a slide member 204 and a retainer bar 206 slidably mounted on the bottom surface 38 of deck 12 and a channel 208 in engagement member 180 of truck mount 28. The slide member 204 is configured to be operated by the user so as to direct the retainer bar 206 into and out of channel 208 after truck mount 28 is placed on truck mount connector 64 and then twisted into position thereon. FIGS. 32 and 36 show the retainer bar 206 received inside channel 208 to substantially lock truck mount 28 to truck mount connector 64. When retainer bar 206 is positioned in channel 208 of engagement member 180, the guide member 176 will not be able to move upward to disengage truck mount 28 from truck mount connector 64 until the user manually operates slide mechanism 202. To unlock truck mount 28 from truck mount connector 64, the user merely moves slide member 204 away from truck mount 28, which is to the right in the figures, so as to move retainer bar 206 out of channel 208. To prevent unintended movement of slide member 204 away from truck mount 28, which could allow truck mount 28 to disengage from truck mount connector 64, the preferred embodiment includes a bar lock member 210 that is attached to or integral with guide member 176, as best shown in FIGS. 34 through 36, which is configured to engage a detent 212, shown in FIG. 36, in retainer bar 206 as retainer bar 206 is slid into position in channel 208, thereby preventing retainer bar 206 from moving out of channel 208. Preferably, bar lock member 210 is part of a living hinge arrangement that is automatically pushed upward by the inward movement of retainer bar 204 until it falls into position in detent 212. Once bar lock member 210 is in position in detent 212, it prevents any further movement, particularly outward movement, of retainer bar 204 to secure truck mount 28 to deck 12 for operation of skateboard 10. The user disengages truck mount 28 from truck mount connector 64 by moving guide member 176 slightly upward to separate bar lock member 210 from the detent 212 in retainer bar 204 and then moving slide member 204 away from truck mount 28 to slide retainer bar 206 out of channel 208. Once retainer bar 206 is out of channel 208, the user can twist truck mount 28 to an approximate right angle and then lift truck mount 28, and its associated truck assembly 26, off of truck mount connector 64 to separate first end section 40 from center section 42 (and likewise for second end section 44).

In use for the embodiment of FIGS. 26 through 31, the user slides the sections of deck 12, such as first end section 40, center section 42 and second end section 44, together to form a substantially unitary deck 12 (if not already provided that way) with one or more truck mount connectors, such as first 64 and second 66 truck mount connectors, thereon. The joining of two adjacent deck sections, such as first end section 40 to center section 42, together places connector components, such as 64a and 64b, in abutting relationship to define truck mount connector 64. Truck mount 28, typically with truck assembly 26 attached thereto, is then placed over truck mount connector 64 (as an example) at a substantially right angle to its normal direction such that mounting cavity 68 fits over truck mount connector 64. The user then twists or rotates truck mount 28 into position, thereby causing engagement member 180 to contact the side of truck mount connector 64, which results in the spring member 168 flexing upward to move engagement member 180 into mounting cavity 68. Continued twisting or rotating will cause engagement member 180 to drop into slot 164, defined by cut-out section 162, to lock truck mount 28 onto truck mount connector 64. In the preferred embodiment, the user then moves guide member 176 downward to engage truck mount securing mechanism 194 by pushing the spring-loaded ball 196 inward until detent 198 is aligned therewith, at which time ball 196 will move partially into the detent 198 and lock engagement member 180 in slot 164 to prevent any unintentional disengagement of truck mount 28 from deck 12. When the user desires to remove truck mount 28 from deck 12, he or she moves guide member 176 upward, pushing ball 196 back into guide member supports 186/188, to move engagement member 180 out of slot 164 and allow the user to twist/rotate truck mount 28 to the right angle position so as to remove it from truck mount connector 64. In the alternative embodiment of FIGS. 32 through 36 with slide mechanism 202, the user locks the truck mount 28 to the truck mount connector 64 by operating the slide member 204 to move the retainer bar 206 into channel 208, which is locked into place by the engagement of bar lock member 210 into detent 212 in retainer bar 206. The user removes truck mount 28 from deck 12 by moving guide member 176 upward to separate bar lock member 210 from detent 212, sliding slide member 204 and retainer bar 206 away from truck mount 28 and then twisting/rotating truck mount 28 to its right angle position so that it can be removed from deck 12.

The preferred embodiment for the truck mount 28 of the present invention is set forth in FIGS. 37 through 42. As discussed in more detail below, this embodiment includes an improved truck mount securing mechanism 194 for latching mechanism 154 that more securely maintains the connection between truck mount 28 and first 64 and second 66 truck mount connectors (as with the above embodiment, references hereinafter to first truck mount connector 64 or truck mount connector 64 are intended to apply equally to second truck mount connector 66 shown in the figures for other embodiments) and is easier to operate to secure or remove truck mount 28 from deck 12. The truck mount 28 of the present embodiment is configured to cooperatively engage the truck mount connector 64 configured as shown in FIG. 27. Much of the above discussion with regard to the embodiment shown in FIGS. 26 through 31, with regard to latching mechanism 154, is also applicable to the embodiment of FIGS. 37 through 41, particularly as to the cooperation between and configuration of mount body 156, mount base 158 and spring member 168. The improved securing mechanism 194 are set forth in the discussion below and the corresponding figures. In summary, these improvements provide a more reliable yet easy to use securing mechanism 194 to allow the user to attach truck mount 28 to deck 12, in the twist-and-lock type configuration previously described, to form skateboard 10 or to remove it therefrom for storage and/or transport.

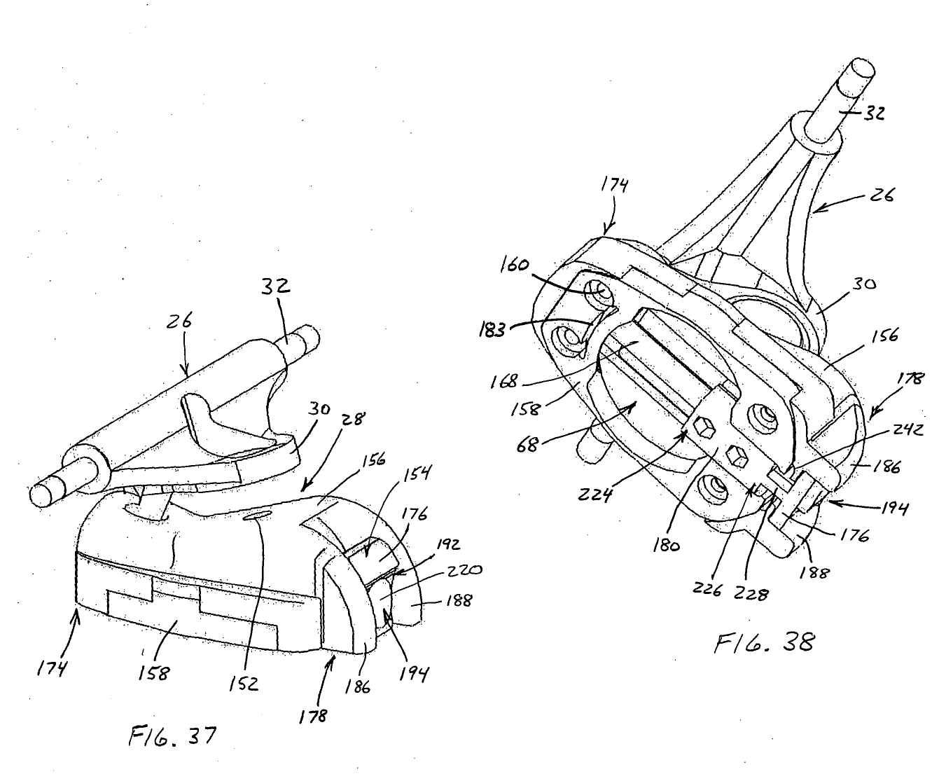

Truck mount 28, shown with truck assembly 26 (minus wheels 34) attached thereto in FIGS. 37 and 38, having the improved securing mechanism 194 includes button 220 that the user operates to move guide member 176 so as to engage or disengage truck mount 28 from the truck mount connector 64. As in the aforementioned embodiment, guide member 176 of latching mechanism 154 moves upward to move engagement member 180, which is attached to spring member 168, out of slot 164 defined by cut-out section 162 so the user may twist truck mount 28 off of truck mount connector 64 to remove truck mount 28 from deck 12 and, if applicable, separate adjoining deck sections, such as first end section 40 and center section 42. As best shown in FIGS. 39 through 42 and described in more detail below, button 220 is received in button aperture 222 in guide member 176 in a manner that prevents guide member 176 from moving upward unless the user sufficiently pushes button 220 inward so as to overcome a biasing force that biases button 220 outward to unlock securing mechanism 194 and allow the user to move guide member 176 upward in guide cavity 190 and displace engagement member 180 from slot 164. Preferably, when the user installs truck mount 28, typically with truck assembly 26 attached thereto, securing mechanism 194 automatically locks guide member 176 in place (alternatively, the user moves guide member 176 downward), displacing button 220 outwardly, when engagement member 180 is received in slot 164.

As previously explained, the first end 170 of spring member 168, which is configured to be straight or substantially straight (or flat) in this embodiment, is secured between mount body 156 and mount base 158 to allow engagement member 180, attached to the second end 172 thereof, to flex upward during disengagement and downward during engagement of truck mount 28 from truck mount connector 64. As best shown in FIGS. 39 and 41, the second end 172 of spring member 168 is received into channel 208 beginning at the first end 224 of engagement member 180 and guide member 176 is located at the second end 226 of engagement member 180. Preferably, engagement member 180 and guide member 176 are integrally formed with a bridge section 228 that interconnects engagement member 180 and guide member 176, which placed are in spaced apart relation with a gap 230 substantially therebetween (except for bridge section 228). In the preferred embodiment, button 220 is biased outwardly by spring 232, as the biasing force, that is disposed between the first end 234 of button 220 and second end 226 of engagement member 180. As explained in more detail below, the user pushes against the second end 236 of button 220 to slide it in button aperture 222 to overcome the biasing force of spring 232 to allow guide member 176 to be slid upward in guide cavity 190.

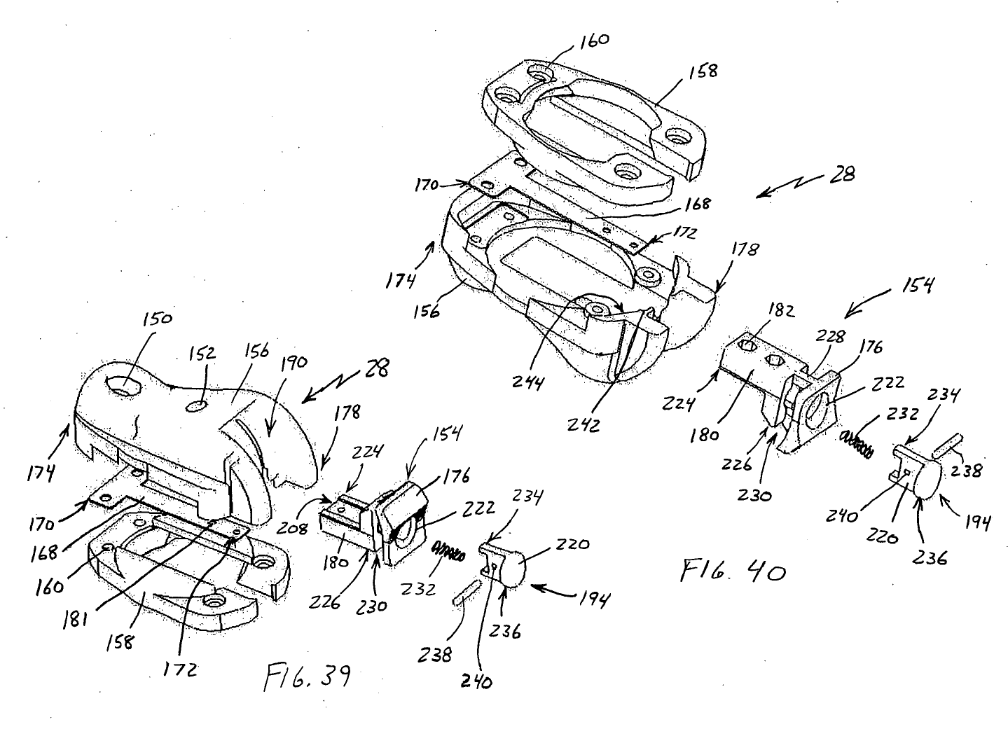

When truck mount 28 is twisted onto truck mount connector 64, the biasing force of spring 232 will displace button 220 outward and lock it and guide member 176 in their locked position. To prevent button 220 from being displaced out of button aperture 222 during use of skateboard 10, latching mechanism 154 includes slide rod 238 that is received in slide rod aperture 240 (the components being best shown in FIGS. 39, 40 and 42) in gap 230. To provide the locking desired for preventing unintentional disengagement of truck mount 28 from truck mount connector 64, securing mechanism 194 includes a rod engaging means that receives slide rod 238 and holds it in place until the user pushes against button 220 to release slide rod 238 and allow guide member 176 to be slid upward in guide cavity 190. In the preferred configuration of this embodiment, rod engaging means is a detent 242 located at the bottom edge of guide sidewall 244 of mounting cavity 68 near the second end 178 of truck mount 28 behind guide cavity 190, as best shown in FIGS. 38 and 40. During normal operation (i.e., non-locked) of latching mechanism 154, slide rod 238 will be biased against guide sidewall 244 by the biasing force of spring 232 and will slide up and down guide sidewall 244 with the up and down movement of guide member 176. The biasing of slide rod 238 against guide sidewall 244 prevents button 220 from being displaced out of latching mechanism 154 through button aperture 222. When truck mount 28 is placed on truck mount connector 64, in the twist-and-lock manner described above, the movement of engagement member 180 into slot 164 will draw guide member 176 and button 220 downward (i.e., when truck mount connector 64 is facing upward as shown in FIG. 27), either automatically or by the user pushing down on guide member 176, to cause slide rod 238 to move into detent 242. As will be readily understood by those skilled in the art, slide rod 238 and detent 242 are cooperatively configured such that slide rod 238 will be securely held in detent 242 until the user pushes inward on button 220 with enough force to overcome the biasing force of spring 232, at which time slide rod 238 will be displaced from detent 242 to slide along guide sidewall 244 of mounting cavity 68 with the movement of guide member 176 in guide cavity 190. In this manner, disengaging truck mount 28 from deck 12 will require more than mere accidental contact against button 220, which contact is possible depending on the use of skateboard 10.

The engagement member 180 is attached to the second end 172 of spring member 168 such that the upward movement of spring member 168, resulting from its contact against truck mount connector 64, will displace the engagement member 180 upward into mounting cavity 68 so that it will slide across the top of truck mount connector 64 to the slot 164 defined by cut-out section 162. When truck mount 28 is placed on truck mount connector 64 and then twisted or rotated into position, the receiving of engagement member 180 into cut-out section 162 and slot 164 prevents further rotation of truck mount 28 and causes slide rod 238 to slide downward along guide sidewall 244 into detent 242, thereby preventing any unintended and undesirable disengagement of truck mount 28, and therefore truck mounting assembly 14/16, from deck 12. Securing mechanism 194 of this embodiment is configured for controlled release of engagement member 180 from slot 164 and, therefore, truck mount 28 from truck mount connector 64 and deck 12. By the user pushing inward on button 220, with sufficient force to overcome spring 232, slide rod 238 is displaced from detent 242 to allow the user to move guide member 176 up guide cavity 190 to remove engagement member 180 from slot 164. The user then can twist or rotate truck mount 28 relative to truck mount connector 64 and remove truck mount 28 from deck 12 to, if applicable, separate deck sections.

In use for the preferred embodiment of FIGS. 37 through 42, the user slides the sections of deck 12, such as first end section 40, center section 42 and second end section 44, together to form a substantially unitary deck 12 (if not already provided that way) with one or more truck mount connectors, such as first 64 and second 66 truck mount connectors, thereon. The joining of two adjacent deck sections, such as first end section 40 to center section 42, together places connector components, such as 64a and 64b, in abutting relationship to define truck mount connector 64. Truck mount 28, typically with truck assembly 26 attached thereto, is then placed over truck mount connector 64 (as an example) at a substantially right angle to its normal direction such that mounting cavity 68 fits over truck mount connector 64. The user then twists or rotates truck mount 28 into position, thereby causing engagement member 180 to contact the side of truck mount connector 64, which results in the spring member 168 flexing upward to move engagement member 180 into mounting cavity 68. Continued twisting or rotating will cause engagement member 180 to drop into slot 164, defined by cut-out section 162, to lock truck mount 28 onto truck mount connector 64. As the engagement member 180 drops into slot 164, the slide rod 238 will slide along slide sidewall 244 until slide rod 238 moves into detent 242, allowing the biasing force of spring 232 to bias button 220 outward. This locks truck mount 28 onto truck mount connector 64 in a manner that prevents unintended disengagement of truck mount 28 from deck 12. In a preferred embodiment, the guide member 176 moves into detent automatically. Alternatively, the user moves guide member 176 downward to engage truck mount securing mechanism 194 by moving slide rod 238 into detent 242 to lock engagement member 180 in slot 164. When the user desires to remove truck mount 28 from deck 12, he or she pushes in on button 220 to disengage slide rod 238 from detent and then moves guide member 176 upward, allowing slide rod 238 to slide against guide sidewall 244, to allow the user to twist/rotate truck mount 28 to the right angle position so as to remove it from truck mount connector 64.

As stated above, disassemblable skateboard 10 of the present invention can utilize a deck 12 manufactured out of a wide variety of different materials, including metals, wood, plastics, composites and others. Many skateboard riders prefer the look and handling characteristics of a deck 12 made out of wood. To provide a multi-section deck 12 out of wood requires a slightly different configuration for the components that connect the separate sections together to form the unitary deck 12. A preferred configuration for a deck 12 made out of wood is shown in FIGS. 43 through 45. This configuration utilizes the truck mount connectors 64 and 66 and the truck mount 28 described with regard to the preferred embodiment shown in FIGS. 37 through 42. As will be readily apparent to those skilled in the art, however, the deck 12 configuration shown in FIGS. 43 through 45 can utilize the various other embodiments of the truck mounting assemblies 14/16 and mounting mechanisms 18/20 described above. In addition, as may be desired, the wood deck 12 configuration can also be adapted to utilize the various securing mechanisms, including those shown as 22 and 24, described herein to more fully attach the truck mount 28, and therefore the truck assembly 26, to the wooden deck 12.

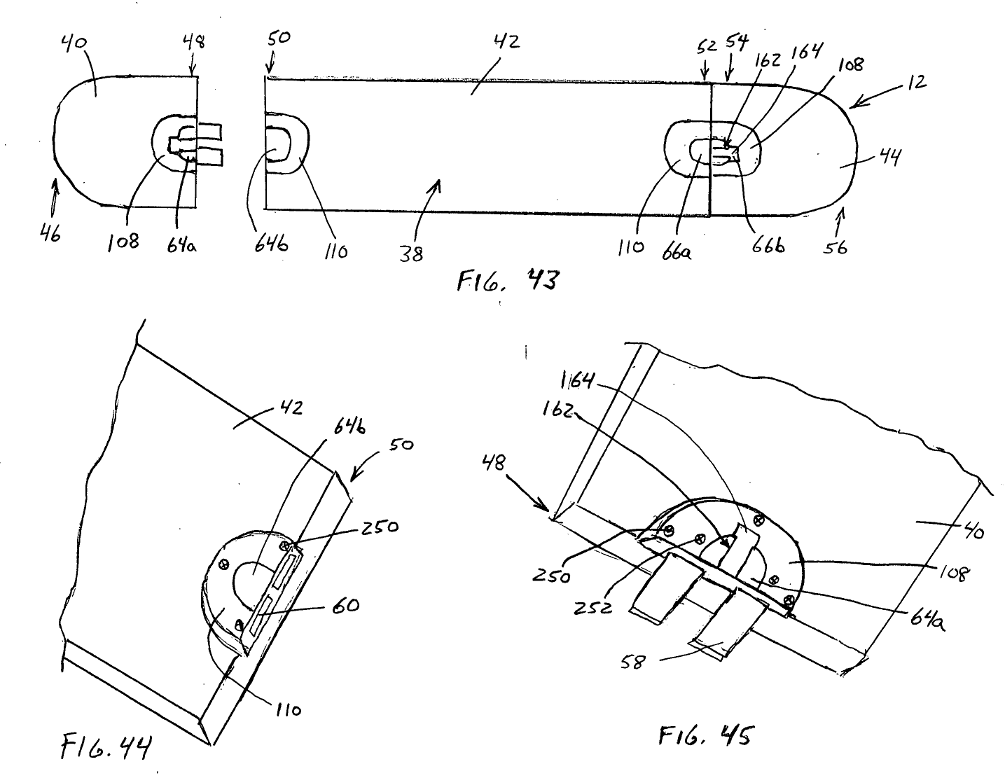

In a preferred configuration, shown in FIGS. 43 through 45, the wooden deck 12 is provided in three sections, first end section 40, center section 42 and second end section 44 that are joined together utilizing a tab plate 108 having one or more pins or tabs 58 (tabs being shown) and one or more sockets 60 in corresponding relation to tabs 58. In this embodiment, a tab plate 108 is located at the second end 48 of first end section 40 and at the first end 54 of second end section 44 and a socket plate 110 is located at each of the first 50 and second 52 ends of center section 42. As shown in FIG. 43 and 45, tabs 58 extend outwardly from end sections 40 and 44 toward the socket plates 110 located on center section 42 to be received in sockets 60, best shown in FIG. 44. In the preferred embodiment, tabs 58 are sized and configured to slide in sockets 60 without any interference from sockets 60 or the use of any locking arrangement between tabs 58 and sockets 60. Alternatively, though not shown, tabs 58 can be engagedly received in sockets 60. In the preferred embodiment, as described in more detail above, each of tab plate 108 and socket plate 110 has one-half of a mounting mechanism 18/20, such as truck mount connectors 64/66. In the configuration shown, the tab plates 108 have truck mount components 64a and 66a and the socket plates 110 have truck mount components 64b and 66b, such that the joining of an end section 40 or 44 to center section 42 forms truck mount connectors 64 and 66 (in the preferred embodiment) for engagement by truck mount 28 of first 14 and second 16 truck mounting assemblies. As discussed above, the mounting of truck mount 28 onto the mounting mechanisms 18/20 secures end sections 40 and 44 onto center section 42 to form a unified deck 12 suitable for skateboard 10 of the present invention.

Tab plate 108 and socket plate 110 can be attached to the bottom surface 38 of deck 12 utilizing one or more plate connectors 250, such as the screws shown or the like, or attached utilizing an adhesive or similar products suitable for the materials utilized for deck 12 and plates 108 and 110. Tabs 58 can be secured to tab plate 108 utilizing tab screws 252 or other types of connecting mechanisms or tabs 58 can be molded or otherwise manufactured integral with tab plate 108. In addition, tab plate 108 and socket plate 110 can be placed in abutting relation to bottom surface 38 or they can be slightly to substantially embedded into bottom surface 38, which will place tabs 58 and sockets 60 near the center (depth) of deck 12. Tab plate 108 and socket plate 110 must be configured to place end sections 40 and 44 in close abutting relation to the respective ends 50 and 52 of center section 42 to avoid any gap between sections that would interfere with the use of skateboard 10. In one embodiment, tab plate 108 and socket plate 110 are made out of aluminum. Other metals or various non-metal materials can also be utilized.

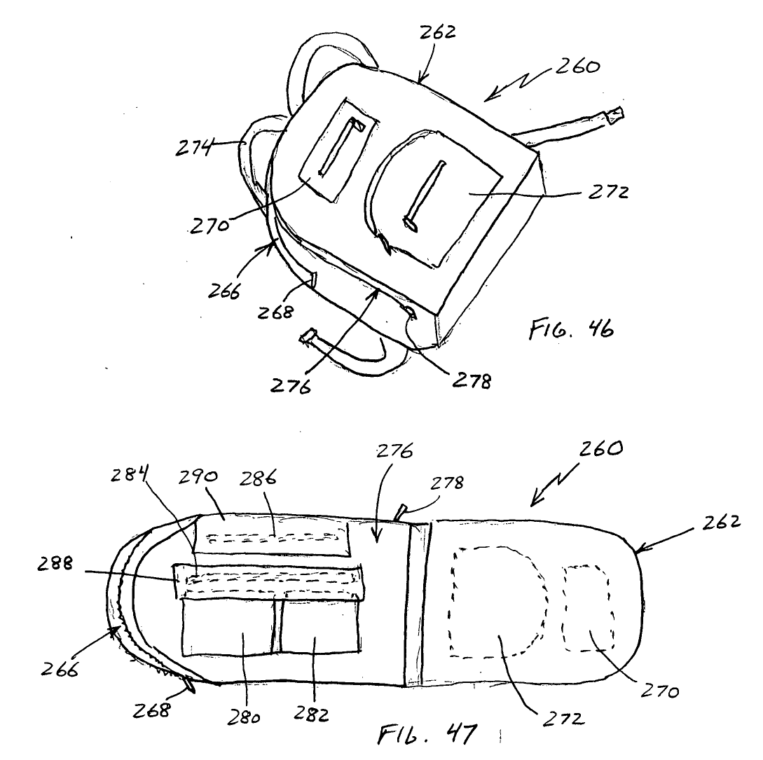

The carrying system of a preferred embodiment of the present invention is shown generally as 260 in FIGS. 46 and 47. Carrying system 260 comprises skateboard 10, configured as described in the various embodiments above, and a carrying case 262, such as the backpack shown in FIGS. 46 and 47. Preferably, for the embodiment shown, backpack 262 is generally configured the same as a typical backpack utilized by many people for carry materials therein, particularly school supplies such as books, paper, pencils and the like. The standard backpack is modified into backpack 262 to carry the separated components of the disassemblable skateboard 10 of the present invention, particularly the sections 40, 42 and 44 of deck 12 and the first 14 and second 16 truck mounting assemblies. As well known, backpack 262 has a cover 264 that encloses one or more interior storage compartments 266 (shown closed with zipper pull 268) for carrying larger items, one or more exterior pockets, such as 270 and 272, for carrying smaller items and straps 274 for the user to carry backpack 262 on his or her back. For carrying system 260, backpack 262 is modified to include an interior skateboard compartment 276 (shown closed with zipper pull 278 in FIG. 46 and open in FIG. 47) that is configured to carry the components of the disassembled skateboard 10.

As shown in FIG. 47, skateboard compartment 276 of the preferred embodiment includes a first end section pocket 280 for first end section 40, a second end section pocket 282 for second end section 44, an elongated center section pocket 284 for center section 42 and a mounting assembly pocket 286 for the truck mounting assemblies 14 and 16. Each of the pockets are sized and configured to receive the respective components therein, preferably in a manner that substantially prevents contact with other components so as to reduce the likelihood of damage to those components. A first flap member 288 covers the opening into the end section pockets 280 and 282 and center section pocket 284 and a second flap member 290 covers the opening into mounting assembly pocket 286. In the preferred embodiment, each of pockets 280, 282, 284 and 286 are open with flaps 288 and 290 configured to prevent the respective components from falling out of the pockets. In a preferred configuration, flaps 288 and 290 have an easy to operate closure mechanism, such as Velcro, snaps, buttons, zippers or the like (not shown, but well known in the art), that sealably closes the pockets 280, 282, 284 and 286. Depending on the size and configuration of carrying case 262, such as whether it is configured more in the shape of a duffle bag, luggage or other type of carrying case (as well as whether it is large or smaller than the backpack), there can be more or less pockets for the components of disassemblable skateboard 10 of the present invention. Carrying case 262 can be manufactured out a wide variety of materials, utilize different compartment closure mechanisms than the zippers shown in FIGS. 46 and 47, be shaped in a variety of different configurations and utilize different pocket closure mechanisms than those set forth as examples above, as long as it has pockets that are substantially shaped and configured to receive one or more components of skateboard 10 in the skateboard compartment 276 thereof.

While there are shown and described herein certain specific alternative forms of the invention, it will be readily apparent to those skilled in the art that the invention is not so limited, but is susceptible to various modifications and rearrangements in design and materials without departing from the spirit and scope of the present invention. In particular, it should be noted that the present invention is subject to modification with regard to assembly, materials, size, shape and use. For instance, some of the components described above can be made integral with each other to reduce the number of separate components and various replacement components can be utilized that perform the same function as those described above.

What is claimed is:

1. A disassemblable skateboard, comprising:
a deck having a top surface and a bottom surface;
an outwardly projecting truck mount connector on said bottom surface of said deck;
a truck mount having a mounting cavity, said mounting cavity shaped and configured to receive said truck mount connector therein and cooperatively engage said truck mount connector so as to releasably attach said truck mount to said deck, said truck mount connector and said truck mount configured for twist-and-lock engagement;
means interconnecting said truck mount connector and said truck mount for removably securing said truck mount to said truck mount connector;
means for removably latching said truck mount to said truck mount connector, said latching means comprising a button slidably disposed in a button aperture on said securing means and a biasing means for biasing said button out of said button aperture; and
a truck assembly attached to or integral with said truck mount, said truck assembly having at least one wheel rotatably attached thereto.

2. The disassemblable skateboard according to claim 1, wherein said truck mount connector comprises at least one projecting lip thereon and said mounting cavity comprises at least one receiving lip thereon, said projecting lip configured to engage said receiving lip to attach said truck mount to said bottom surface of said deck.

3. The disassemblable skateboard according to claim 1, wherein said securing means comprises an elongated spring member, a guide member and an engagement member on said truck mount and a slot in said truck mount connector, said spring member interconnecting said truck mount and said guide member, said engagement member attached to or integral with said spring member and sized and configured to be received in said slot, said spring member configured to bias said engagement member into said slot.

4. The disassemblable skateboard according to claim 3, wherein said button aperture is on said guide member and said button is cooperatively configured with said guide member to selectively move said engagement member out of said slot and allow removal of said truck mount from said truck mount connector.

5. The disassemblable skateboard according to claim 4, wherein said truck mount comprises a pair of guide member supports defining a guide cavity, said guide member slidably disposed in said guide cavity between said guide member supports, said latching means configured to secure said guide member in said guide cavity so as to prevent said engagement member from moving out of said slot.

6. The disassemblable skateboard according to claim 5, wherein said latching means further comprises a slide rod connected to said button and a detent on said truck mount configured to receive said slide rod when said biasing means biases said button so as to secure said guide member in said guide cavity and said engagement member in said slot.

7. The disassemblable skateboard according to claim 1, wherein said deck comprises two or more deck sections and said truck mount connector comprises two or more connector components, at least one of said connector components on each of said deck sections, said mounting cavity of said truck mount configured to hold said connector components together so as to abuttingly join said deck sections together.

8. The disassemblable skateboard according to claim 7, wherein said deck comprises a first end section, a second end section and a center section disposed between said first end section and said second end section.

9. The disassemblable skateboard according to claim 8, wherein said skateboard comprises a first truck mount connector on said deck configured to removably mount a first truck mount to said bottom surface of said deck so as to abuttingly join a second end of said first end section to a first end of said center section and a second truck mount on said deck configured to removably mount a second truck mount to said bottom surface of said deck so as to abuttingly join a first end of said second end section to a second end of said center section.

10. A disassemblable skateboard, comprising:
a deck having a top surface and a bottom surface, said deck comprising at least two deck sections configured to be placed in adjoining relation;
an outwardly projecting truck mount connector on said bottom surface of said deck, said truck mount connector having at least one projecting lip thereon, said truck mount connector formed from two connector components, one of said connector components on each of said two deck sections;
a truck mounting assembly having a truck assembly and a truck mount, said truck assembly having at least one wheel rotatably attached thereto, said truck mount attached to or integral with said truck assembly, said truck mount connector and said truck mount configured for twist-and-lock engagement, said truck mount having a mounting cavity configured to receive said truck mount connector therein so as to releasably mount said truck mounting assembly to said deck, said mounting cavity having at least one receiving lip thereon, said projecting lip configured to engage said receiving lip to attach said truck mount to said bottom surface of said deck said truck mount configured to hold said two connector components together so as to abuttingly join said two deck sections together;
means interconnecting said truck mount connector and said truck mount for removably securing said truck mount to said truck mount connector; and
means for removably latching said truck mount to said truck mount connector, said latching means comprising a button slidably disposed in a button aperture on said securing means and a biasing means for biasing said button out of said button aperture.

11. The disassemblable skateboard according to claim 10, wherein said securing means comprises an elongated spring member, a guide member and an engagement member on said truck mount and a slot in said truck mount connector, said spring member interconnecting said truck mount and said guide member, said engagement member attached to or integral with said spring member and sized and configured to be received in said slot, said spring member configured to bias said engagement member into said slot.

12. The disassemblable skateboard according to claim 11, wherein said button aperture is on said guide member and said button is cooperatively configured with said guide member to selectively move said engagement member out of said slot and allow removal of said truck mount from said truck mount connector.

13. The disassemblable skateboard according to claim 12, wherein said truck mount comprises a pair of guide member supports defining a guide cavity, said guide member slidably disposed in said guide cavity between said guide member supports, said latching means configured to secure said guide member in said guide cavity so as to prevent said engagement member from moving out of said slot.

14. The disassemblable skateboard according to claim 13, wherein said latching means further comprises a slide rod connected to said button and a detent on said truck mount configured to receive said slide rod when said biasing means biases said button so as to secure said guide member in said guide cavity and said engagement member in said slot.

15. The disassemblable skateboard according to claim 12, wherein said deck comprises a first end section, a second end section and a center section disposed between said first end section and said second end section, said skateboard further comprising a first truck mount connector on said deck configured to removably mount a first truck mount to said bottom surface of said deck so as to abuttingly join a second end of said first end section to a first end of said center section and a second truck mount connector on said deck configured to removably mount a second truck mount to said bottom surface of said deck so as to abuttingly join a first end of said second end section to a second end of said center section.

16. The disassemblable skateboard according to claim 15 further comprising a tab plate at each of said second end of said first end section and said first end of said second end section and a socket plate at each of said first end of said center section and said second end of said center section, each of said tab plates having one or more tabs extending outwardly therefrom, each of said socket plates having one or more sockets, each of said sockets sized and configured to receive one of said tabs therein, said tab plates cooperatively arranged with said socket plates for said tabs to be received in said sockets when said deck sections are placed in adjoining relation.

17. The disassemblable skateboard according to claim 10 further comprising one or more tab plates on at least one of said at least two deck sections and one or more socket plates on at least one of said at least two deck sections, said tab plates having one or more tabs extending outwardly therefrom, said socket plates having one or more sockets, each of said sockets sized and configured to receive one of said tabs therein, one of said tab plates cooperatively arranged with one of said socket plates for said tabs to be received in said sockets when said deck sections are placed in adjoining relation.

18. A disassemblable skateboard, comprising:
a deck having a top surface and a bottom surface, said deck comprising at least a first deck section and a second deck section configured to be placed in adjoining relation;
a truck mounting assembly having a truck assembly and a truck mount, said truck assembly having at least one axle and at least one wheel rotatably attached to said axle, said truck mount attached to or integral with said truck assembly;
means on said bottom surface of said deck for releasably mounting said truck mounting assembly to said deck, said mounting means configured to cooperatively engage said truck mount;
means for securing said truck mounting assembly to said bottom surface of said deck, said securing means releasably interconnecting said bottom surface of said deck to said truck mount;
a tab plate on said first deck section, said tab plate having one or more tabs extending outwardly therefrom; and
a socket plate on said second deck section, said socket plate having one or more sockets, each of said sockets sized and configured to receive one of said tabs therein, said tab plate cooperatively arranged with said socket plate for said tabs to be received in said sockets when said first deck section and said second deck section are placed in adjoining relation.

19. The disassemblable skateboard according to claim 18, wherein said deck comprises a first end section, a second end section and a center section disposed between said first end section and said second end section, a first truck mounting assembly configured to abuttingly join a second end of said first end section to a first end of said center section, and a second truck mounting assembly configured to abuttingly join a first end of said second end section to a second end of said center section, said skateboard having one of said tab plates at each of said second end of said first end section and said first end of said second end section and one of said socket plates at each of said first end of said center section and said second end of said center section.

20. A skateboard carrying system, comprising:
a disassemblable skateboard having a deck, a truck mounting assembly, means on said deck for releasably mounting said truck mounting assembly to a surface of said deck and means for securing said truck mounting assembly to said surface, said deck comprising at least two deck sections configured to be placed in adjoining relation, said truck mounting assembly having a truck assembly and a truck mount, said truck assembly having at least one wheel rotatably attached thereto, said truck mount attached to or integral with said truck assembly, said mounting means configured to cooperatively engage said truck mount, said securing means releasably connecting said truck mount to said surface of said deck; and
a carrying case having a skateboard compartment cooperatively configured to carry each of said deck sections and said truck mounting assembly.

21. The system according to claim 20 further comprising one or more pockets in said skateboard compartment, each of said pockets configured to receive at least one of said deck sections or said truck mounting assembly.

22. The disassemblable skateboard according to claim 20, wherein said deck comprises a first end section, a second end section and a center section disposed between said first end section and said second end section, a first truck mounting assembly configured to abuttingly join a second end of said first end section to a first end of said center section, a second truck mounting assembly configured to abuttingly join a first end of said second end section to a second end of said center section, one or more end section pockets to receive at least one of said first end section and said second end section, a center section pocket to receive said center section, and at least one mounting assembly pocket to receive at least one of said first truck mounting assembly and said second truck mounting assembly.
